(19) United States
(12) Patent Application Publication
(10) Pub. No.: US 2016/0012235 A1
(43) Pub. Date: Jan. 14, 2016

(54) ANALYSIS AND DISPLAY OF CYBERSECURITY RISKS FOR ENTERPRISE DATA

(71) Applicant: Vivo Security Inc., Los Altos, CA (US)

(72) Inventors: Thomas Elliott Lee, Los Altos, CA (US); Spencer Elliott Graves, San Jose, CA (US); Paul Borchardt, San Francisco, CA (US); Chuck Chan, San Francisco, CA (US)

(21) Appl. No.: 14/619,063

(22) Filed: Feb. 10, 2015

Related U.S. Application Data
(60) Provisional application No. 61/938,136, filed on Feb. 10, 2014.
(60) Provisional application No. 62/080,982, filed on Nov. 17, 2014.

(51) Int. Cl. G06F 21/57; G06F 17/30

(52) U.S. Cl. CPC G06F 21/577; G06F 17/30082; G06F 2221/034

(57) ABSTRACT

Systems and methods estimate expected loss risk to computers and enterprises based on the data files present on computers and data file clusters within the enterprise.

### CROSS REFERENCE TO RELATED APPLICATIONS

This application claims priority from provisional patent application 61/938,136, filed 2014 Feb. 10. This application also claims priority from provisional patent application 62/080,982 filed 2014 Nov. 17. All referenced documents and application herein and all documents referenced therein are incorporated by reference for all purposes. This application may be related to other patent applications and issued patents assigned to the assignee indicated above. These applications and issued patents are incorporated herein by reference to the extent allowed under applicable law.

### COPYRIGHT NOTICE

Pursuant to 37 C.F.R. 1.71(e), applicant notes that a portion of this disclosure contains material that is subject to and for which is claimed copyright protection (such as, but not limited to, source code listings, screen shots, user interfaces, or user instructions, or any other aspects of this submission for which copyright protection is or may be available in any jurisdiction.). The copyright owner has no objection to the facsimile reproduction by anyone of the patent document or patent disclosure, as it appears in the Patent and Trademark Office patent file or records. All other rights are reserved, and all other reproduction, distribution, creation of derivative works based on the contents, public display, and public performance of the application or any part thereof are prohibited by applicable copyright law.

### BACKGROUND

The discussion of any work, publications, sales, or activity anywhere in this submission, including in any documents submitted with this application, shall not be taken as an admission that any such work constitutes prior art. The discussion of any activity, work, or publication herein is not an admission that such activity, work, or publication existed or was known in any particular jurisdiction.

The economic and competitive threat posed by cybersecurity incidents particularly in large and diverse enterprises is a growing concern. Currently, information technology (IT) professionals and enterprise management largely rely on non-rigorous and/or subjective assessments of value at risk for any particular data file or computer and of the expected loss risk to the enterprise over a period of time. This can result in misapplication of resources in addressing potential cybersecurity risks.

Prior patents issued to inventors associated with this patent have discussed approaches to assessing cybersecurity threats. U.S. Pat. No. 8,893,281 (Lee and Wilson), issued 2014 Nov. 18, entitled Method and apparatus for predicting the impact of security incidents in computer systems, discussed systems and methods that gather information within a network of computers regarding the distribution of documents to calculate the impact of a cyber security incident for a given computer. Specific embodiments analyze word usage within data files to determine that data files are different versions of a document and further use presence of documents on a given computer to determine the impact of a security breach at that computer.

U.S. Pat. No. 8,914,880 (Lee), issued 2014 Dec. 16, entitled Mechanism to calculate probability of a cyber security incident, discusses systems and methods that calculate the probability of a cybersecurity incident occurring for a given computer by correlating the distribution of computer program files with the occurrences of incidents across a large number of computers.

### SUMMARY

The present invention is involved with methods and systems to categorize, inventory, and assess the potential negative impact (or cost) on an enterprise from cybersecurity incidents. Systems and methods as described herein address a number of difficulties that an enterprise faces in managing and taking appropriate steps to reduce cybersecurity incident costs. Systems and methods as described herein can automatically identify, inventory, and group structured and/or unstructured data in an enterprise, can identify and inventory various computing devices within the enterprise that contain or have access to the data, can automatically determine an estimated cost (e.g., value at risk) to the enterprise from various types of incidents involving particular data, computing devices, and etc., and can use those estimates to estimate expected losses or costs to the enterprise from various classifications of cybersecurity incidents. Specific embodiments thus provide objective, quantized, itemized, and statistically rigorous assessments and inventories of cybersecurity threats to enterprises managers. This information allows managers to more effectively reduce, guard against, insure, or otherwise appropriately mitigate cybersecurity threats. According to specific embodiments, systems and methods as described herein further provide identification of specific data, or computer systems, or departments of with high expected loss from cybersecurity threats. According to specific embodiments, the objective, quantized, itemized, and statistically rigorous assessments provided by systems and methods as described herein can further provide effective and potentially interactive display and/or modeling of cybersecurity threats to allow managers to better explore and evaluate potential mitigation efforts.

Systems and methods according to specific embodiments and various specific aspects and embodiments will be better understood with reference to the following drawings and detailed descriptions. For purposes of clarity, this discussion refers to devices, methods, and concepts in terms of specific examples. However, these systems, methods, and aspects thereof may have applications to a variety of types of devices and systems. It is therefore intended that the scope of the invention not be limited except as provided in the attached claims and all allowable equivalents.

Furthermore, it is well known in the art that logic systems and methods such as described herein can include a variety of different components and different functions in a modular fashion. Different example specific embodiments and implementations can include different mixtures of elements and functions and may group various functions as parts of various elements. For purposes of clarity, embodiments of the invention are described in terms of systems that include many different combinations of innovative components and known components. No inference should be taken to limit the claimed invention to combinations containing all of the innovative components listed in any illustrative embodiment in this specification.

In some of the drawings and detailed descriptions below, the present invention is described in terms of the important independent embodiment of a system operating on a digital data network. This should not be taken to limit the claimed invention, which, using the teachings provided herein, can be applied to other situations, such as cable television networks, telephone networks, wireless networks, etc.

All references, publications, patents, and patent applications cited herein are hereby incorporated by reference in their entirety for all purposes.

### BRIEF DESCRIPTION OF THE DRAWINGS

The novel features according to specific embodiments are set forth with particularity in the appended claims. A better understanding of the features and advantages will be obtained by reference to the following detailed description that sets forth illustrative embodiments and the accompanying drawings (also “figure” and “FIG.” herein), of which:

FIG. 1 illustrates an iterative method for calculating Expected Loss Risk to a computer in a computer system.

FIG. 2 illustrates an iterative method for assigning circulation pattern values to documents.

FIG. 3 illustrates an iterative method for assigning mean and standard deviation values to circulation patterns.

FIG. 4 illustrates the financial impact to an enterprise in dollars vs. the incident frequency in years. In this example, each point along the respective lines in the graph represents the predicted frequency with which an impact of that value or higher will occur.

FIG. 5 illustrates a method for obtaining a probability distribution for losses due to cybersecurity incidents.

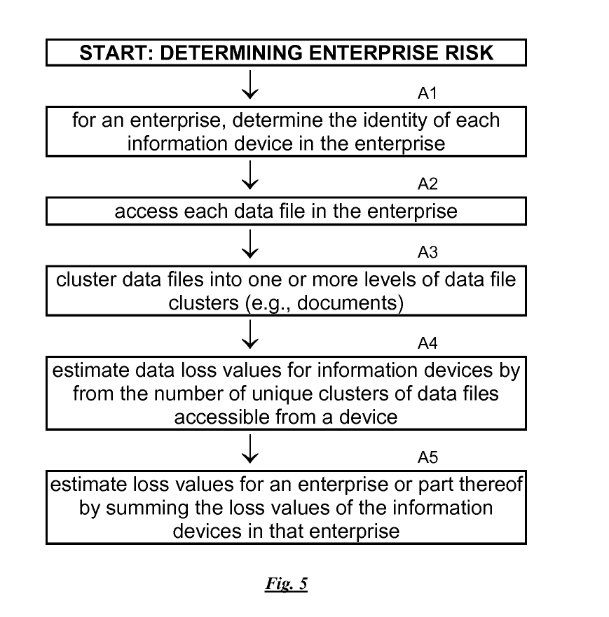

FIG. 6 illustrates a method for obtaining a probability distribution for losses due to cybersecurity incidents.

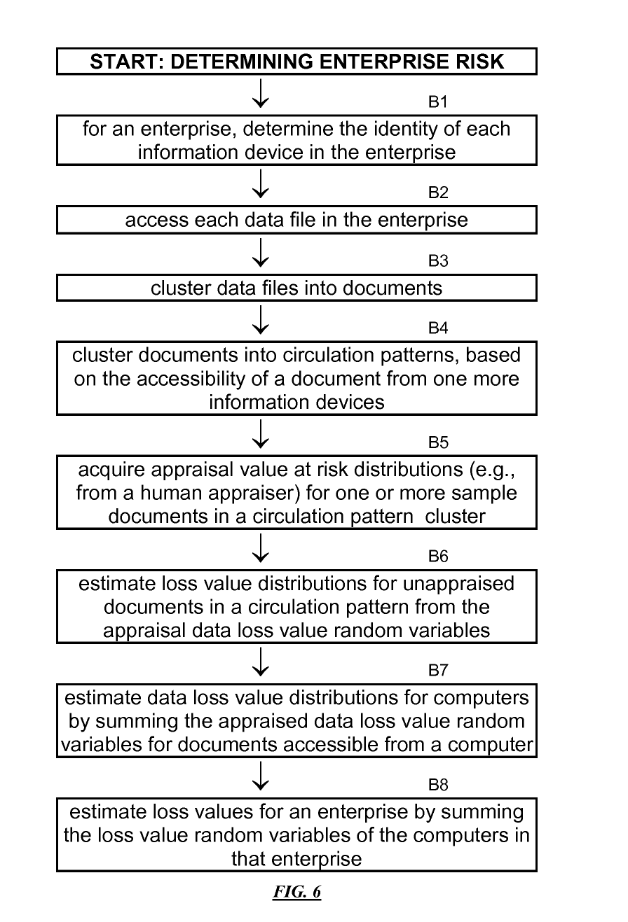

FIG. 7 displays the annual cybersecurity risk for a plurality of individual computing devices in an enterprise The y-axis represents individual computers (or optionally groups of computers) grouped by departments (as shown in parenthesis) and the x-axis represents the risk for each computer. In this example, the estimated risk is scaled and presented in US dollars.

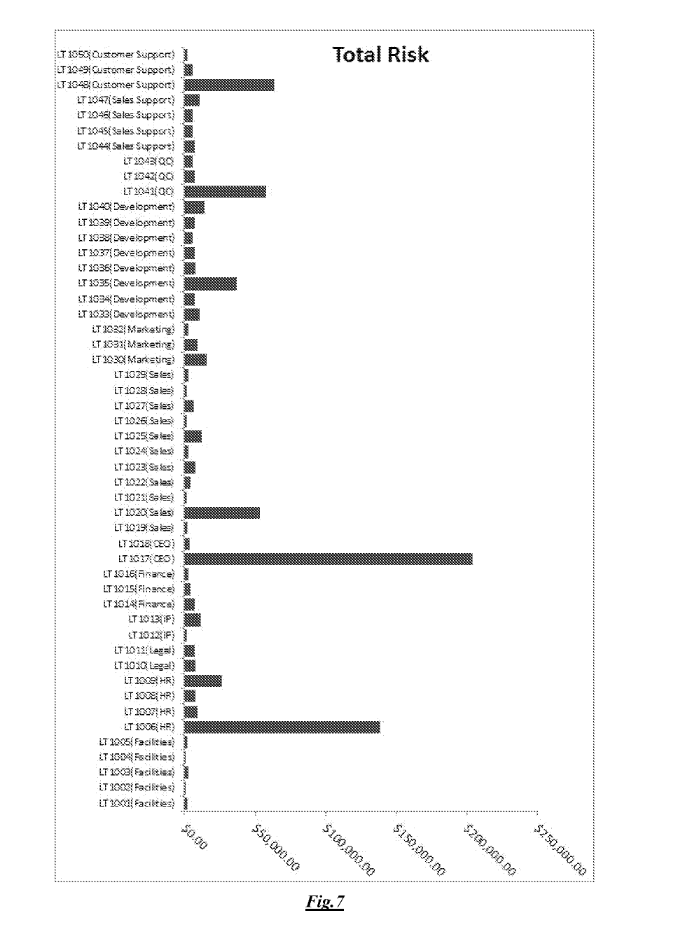

FIG. 8 illustrates annual risk as in FIG. 7, but showing four different cybersecurity incident types: lost or stolen laptops, short term espionage, long term espionage, and internal espionage. The different fill patterns in the horizontal bars indicates the incident types.

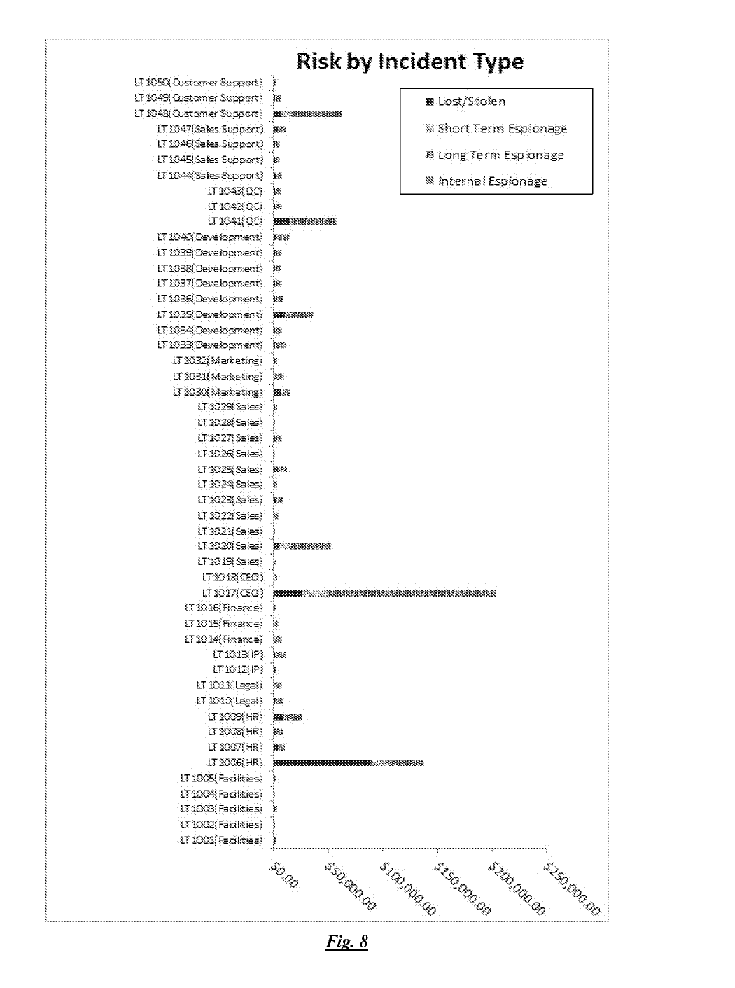

FIG. 9 illustrates annual risk as in FIG. 7, but showing three different data types in the x-axis: custodial, proprietary, and third-party. The different fill patterns in the horizontal bars indicates the data types.

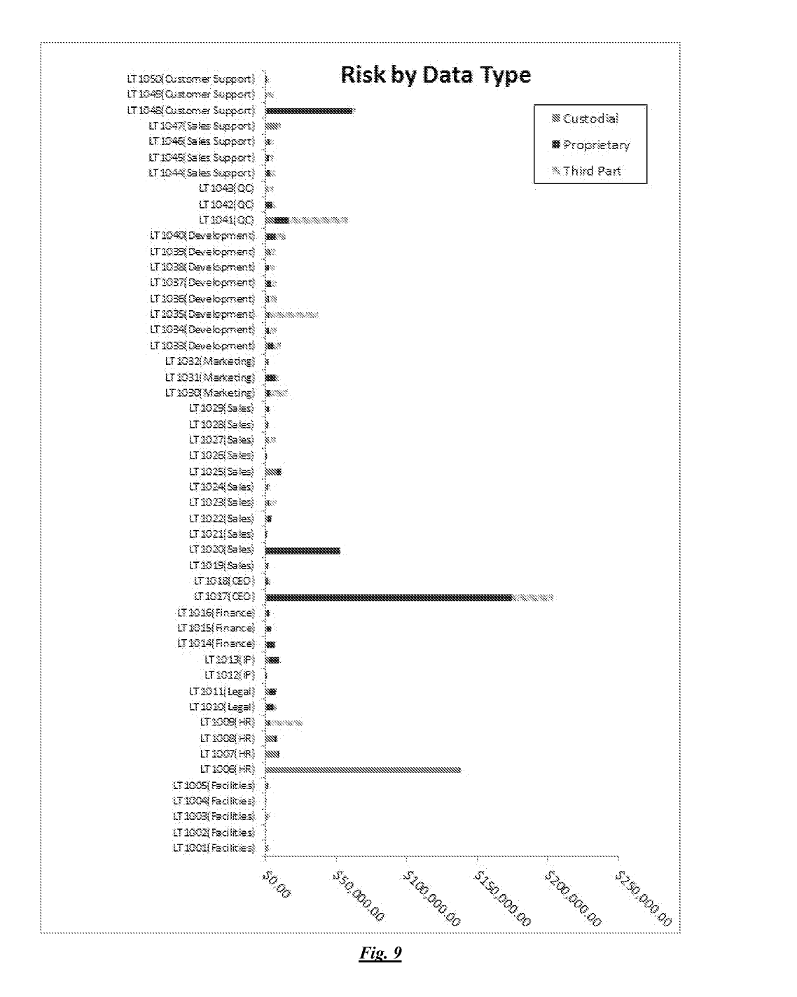

FIG. 10 illustrates annual risk as in FIG. 7, but showing risk from long-term espionage for three different data types: custodial, proprietary, and third-party.

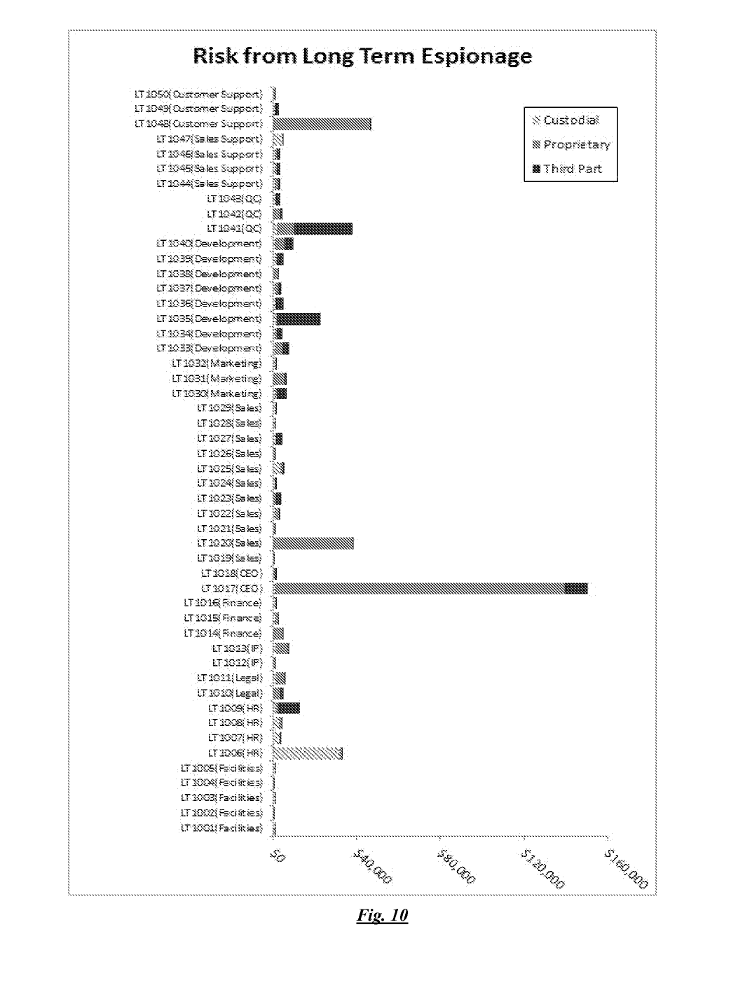

FIG. 11 illustrates the value at risk at the present time (after the scan at Δt=0) for an enterprise in US dollars. The Value at risk is divided into three data types custodial, proprietary, and third party.

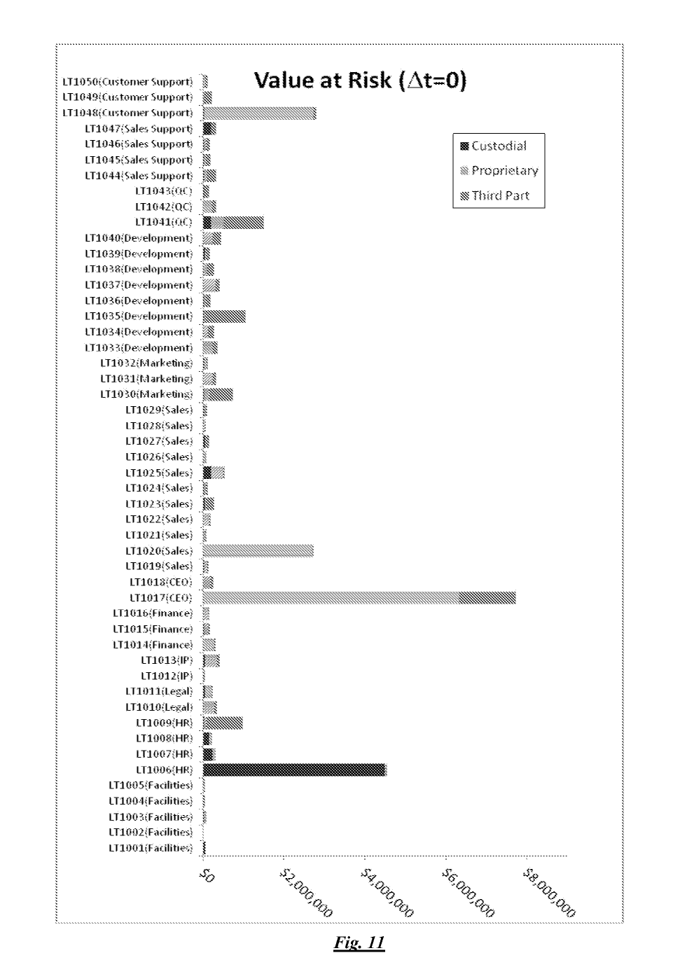

FIG. 12 illustrates the interaction of a computer program with a query database, databases and backup files used in a method for calculating the expected loss from cybersecurity incidents involving the databases and backup files that generally hold structured data.

FIG. 13 is a block diagram showing a representative example logic device in which various aspects of the present invention may be embodied.

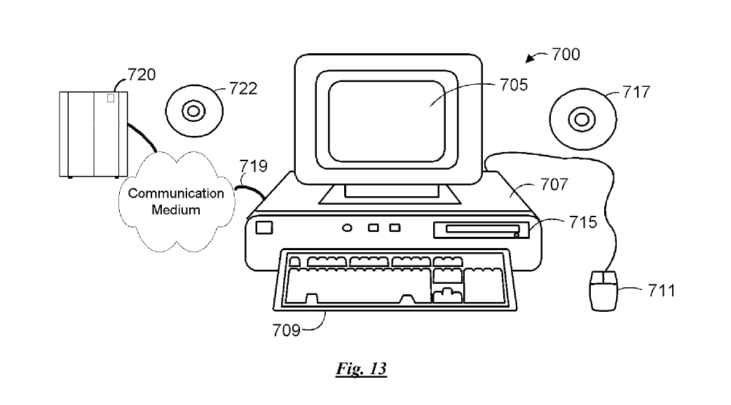

### DESCRIPTION OF SPECIFIC EMBODIMENTS

Before describing the present invention in detail, it is to be understood that this invention is not limited to particular systems or methods, which can vary. It is also to be understood that the terminology used herein is for the purpose of describing particular embodiments only, and is not intended to be limiting. As used in this specification and the appended claims, the singular forms “a”, “an” and “the” include plural referents unless the content and context clearly dictates otherwise. Thus, for example, reference to “a device” includes a combination of two or more such devices, and the like.

Unless defined otherwise, technical and scientific terms used herein have meanings as commonly understood by one of ordinary skill in the art to which the invention pertains. Although any methods and systems similar or equivalent to those described herein can be used in practice or for testing of the present invention, the preferred materials and methods are described herein.

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least” or “greater than” precedes the first numerical value in a series of two or more numerical values, the term “at least” or “greater than” applies to each one of the numerical values in that series of numerical values.

Table 1 provides a brief reference list of some of the terms used herein to describe specific embodiments. This list is not exhaustive and the descriptions provided therein are not intended to limit specific terms, which shall be given their broadest meaning in light of the specification as a whole and the attached claims.

TABLE 1
Term

| | |
|---|---|
| Computer | As used herein, any digital information hardware device that handles any |
| | manner of digitally encoded data. As used herein, computer can indicate a |
| | mobile or smart phone, a tablet, a workstation, a desktop computer, a laptop |
| | or notebook. For convenience, enterprise computer systems are described |
| | herein containing different types of computing devices, but methods and |
| | systems described herein can also be applied to systems entirely or almost |
| | entirely comprising smart phones, for example, as well as systems almost |
| | entirely comprising computer servers. |
| Cybersecurity | A cybersecurity incident, actual or predicted, that results in financial loss for |
| Incident | an enterprise or company where the loss is associated with a compromise of |
| | digital data or digital services (such as access to digital data) that exists |
| | within the enterprise. |
| Structured Data | Data that is stored in a structured generally queryable database, e.g., an SQL |
| | server database. |
| Unstructured Data | Data that is not stored in a structured database, such as text files, slide |
| | presentations and spreadsheets distributed across computers within an |
| | enterprise. |
| Value at Risk | An estimated cost to an enterprise of particular data (and by extension, |
| | computers, departments, groups, etc. containing that data) if that data is |
| | compromised in a cybersecurity incident. According to specific |
| | embodiments, the value at risk is expressed and calculated as a random |
| | variable or vector to account for the various probabilities that compromised |
| | data will actually be used in such a way as to impose a cost on the |
| | enterprise. |
| Incident | Probability or rate that various cybersecurity incidents occur as applied to |
| Probability/Rate | an enterprise or any component thereof. According to specific |
| | embodiments, this is expressed as a random variable or range or |
| | distribution; |
| Loss | A random variable or probability with a probability distribution indicating |
| | the likely generally financial impact of the loss from a cybersecurity |
| | incident that occurs in a specified time period (e.g. one year) involving a |
| | particular file, data cluster, enterprise or part thereof. Loss is the value at |
| | risk or some fraction, with the fraction depending on the incident type. Loss |
| | is 0 if there is no relevant cybersecurity incident. |
| Expected Loss | The expected impact (expressed financially, though it can include financial |
| | estimates of intangibles such as loss to reputation or of customer goodwill) |
| | during a given time period for a given component of an enterprise taking |
| | into account the loss random variable and the probability of cybersecurity |
| | incidents. Expected loss for a particular component of an enterprise (e.g., a |
| | file, document, database, department, computer, group of computers, etc.) is |
| | generally expressed as a value. |
| Data File | As used herein, a data file indicates generally one instance of a digital data |
| | file stored in an enterprise. Thus, a single computing device might have |
| | multiple copies of a data file stored thereon. A data file instance can also be |
| | referred to as a document instance, as described below. |
| Document, | Systems and methods according to specific embodiments identify |
| Unique Document, | documents within an enterprise by scanning and analyzing data files and |
| Document Entry, or | determining which data files are closely related enough so as to be |
| Data File Cluster | considered versions of the same document. In specific embodiments, a |
| | document can be understood as a cluster of data files that are potentially |
| | spread and circulated throughout the system, with many data files in the |
| | cluster being identical (but for instance stored in different locations in the |
| | enterprise) and other data files in the cluster being variations or revisions |
| | that are similar enough to be considered the same document according to |
| | specific embodiments discussed herein. In specific implementations, a |
| | document or document entry refers to all the information a system or |
| | method described herein has determined and usually stored about the |
| | document. That information can include the history, storage location, and |
| | any other attributes about the data files that are instances of the document |
| | throughout an enterprise. That information can also include analysis of |
| | document content such as a summary, histograms, topic models, document |
| | content type, etc. Thus, a document as used herein generally refers to a |
| | grouping of generally unstructured data files that are treated or evaluated |
| | similarly in estimating cybersecurity loss risks or a record of that grouping |
| | stored according to specific embodiments in a database to perform further |
| | analysis. A document according to specific embodiments also refers to a |
| | unifying unit for which a value at risk is calculated. Thus, the value at risk |
| | for a computer or group of computers (e.g., a department) that is attributable |
| | to one document is considered the same regardless of how may copies or |
| | versions of the document are compromised by loss of compromise of the |
| | computer. In some earlier descriptions the term DocCluster was also used. |
| Evaluation Cluster, | For unstructured data, a value at risk cluster is a grouping of unique |
| Document Cluster, | documents that is used to facilitate value at risk calculations for individual |
| or Value At Risk | documents. Because the number of different documents in an enterprise can |
| Cluster | be extremely large, this second level clustering is used for estimating value |
| | at risk for document. In specific embodiments, circulation patterns are used |
| | as the primary value-at-risk clusters. In alternative embodiments, other |
| | document clustering, such as topic modeling, is used instead of or in |
| | supplement to circulation patterns. For structured data, value at risk |
| | clustering can indicate any grouping of structured data records that is used |
| | in the calculation of value at risk for records or database files. At times |
| | herein, the discussion refers to the value at risk for a circulation patterns or a |
| | cluster. This should be understood as the value at risk determine for a |
| | cluster and then assigned to each member of the cluster (e.g., each unique |
| | document) for the purposes of determine expected loss and value at risk for |
| | computers and other components of the enterprise. |
| Circulation Pattern | A cluster of documents based on a presence history indicating where and |
| | when data files are found during an enterprise file scan The circulation |
| | pattern, like a document, is also an entry in a database according to specific |
| | embodiments used to evaluate cybersecurity risks. The circulation pattern |
| | entry generally will include a list of departments or other grouping of |
| | computers containing or previously accessing instances of a document (e.g., |
| | data files). An circulation patterns entry can also, according to specific |
| | embodiments, include any other data relevant to the histories of data files in |
| | the document cluster such as creation and modification dates and users, data |
| | file access information, total number of document instances on a particular |
| | computer, location (e.g., directory) within a particular computer, etc. |
| Department | A grouping of computers used in cybersecurity risk analysis according to |
| | specific embodiments. A department can be one computer, such as the |
| | CEO computer, or many computers, such as all computers with human |
| | resources (HR) |

Methods and systems described herein provide automated and objective statistical techniques for inventorying, evaluating, and/or estimating value at risk from cybersecurity incidents in a enterprise. In specific embodiments, value at risk can be rigorously estimated for individually and specifically identified data, data clusters, computers, departments, etc., of an enterprise. Value at risk can also be rigorously estimated for different types of data and different types of cybersecurity incidents. The expected or predicted loss (or cost) for each of these different categorizations can also be estimated and presented to a user.

Methods and systems according to specific embodiments use various probabilistic or statistical modeling to characterize one or more of: (1) the chance or likelihood or probability that a cybersecurity incident or particular type of cybersecurity incidents will occur in a given time (e.g., the incident rate); (2) the probability distribution of the cost to the enterprise if a particular data file, data cluster, computer, etc. is compromised (e.g., the value at risk); (3) the expected loss over a given period to the enterprise due to one or more cybersecurity incidents affecting one or more components of the enterprise. According to specific embodiments, systems and methods as described herein use one or more specific or itemized risk or loss estimates to further provide statistical estimates and analysis of combined expected loss and risks, such as the overall likely cybersecurity costs to an enterprise, or a department, or a class of devices (e.g., smart phones, laptops, desktop computers), or an individual, over a particular period, such as a day, month, year, or decade. According to specific embodiments, methods and systems as described herein employ rigorous, multifactored, statistical analysis at levels of detail from the individual data files or data items in the enterprise to the whole enterprise to provide the most useful estimates and modeling to management regarding expected loss from cybersecurity incidents.

Automated techniques for estimating potential financial loss from cybersecurity incidents allow the modeling or assessment of various risk mitigation policies. Modeling tools according to specific embodiments allow management to avoid overspending (e.g., adopting policies that are more costly than their associated reduction in risk), under spending (e.g., adopting policies that devote insufficient resources to cybersecurity threats) and misallocation (i.e., devoting resources to the wrong areas).

Estimating and analyzing expected loss cost of compromised electronic data in an enterprise in a rigorous way is generally not possible for human reviewers because of the nature and volume of data files and electronic records that must be examined, particularly the dynamic aspects of data stored or accessed in large enterprises. Even with smaller enterprises, human reviewers cannot provide timely analysis that is required for the comparison of different modeling scenarios. On the other hand, current automated methods suffer from the inability to adequately ascertain the value at risk of electronically accessible or stored data.

### Clustering Data to Estimate Value at Risk

According to specific embodiments, methods and systems as described herein use one or more novel techniques for evaluating the cost or impact to an enterprise (or value at risk) from compromise of particular components of enterprise data. Further embodiments calculated the expected loss (or risk) over time of particular data, computers, or other information resources in an enterprise.

In an example method, data on one or more computers in an enterprise (or an appropriate statistical sample of such data or computers) are automatically scanned and analyzed to determine one or more clusters, groupings or generalizations of data. Typically, data with substantially equivalent attributes are clustered or grouped together. These data clusters are then evaluated using various methods as discussed below to determine the likely cost (value at risk) if the data is compromised. Value at risk determinations for data in the enterprise are used to evaluate or estimate the likely or potential or expected loss (e.g., financial cost) to the enterprise from cybersecurity incidents. In some embodiments, the data to be analyzed are classified as structured (e.g., contained in structured databases), unstructured (e.g., contained in various types of digital files), or a combination thereof. Examples of unstructured data include, but are not limited to, text files, spread sheets, and slide presentations.

In specific embodiments, methods are provided for converting expert evaluations of value at risk of particular items into estimates or probability expressions (e.g., random variables or vectors) and using those estimates or probability expressions to automatically determine the value at risk and/or expected loss for all or a subset of data in an enterprise and by extension for any one or all or a subset of computing devices in the enterprise. In particular embodiments, expert evaluations include evaluations about value at risk of particular data or data clusters that are generated by a computer program, including machine learning algorithms or other forms of artificial intelligence programs.

### Incident Probability

According to specific embodiments, the various rates or likelihoods of cybersecurity incidents are taken from standard industry accepted values (e.g., general rates in particular industries of laptops being lost or stolen) or are derived from previous experience within an enterprise and are expressed as random variables or probability distributions.

### Average Annual Risk (Expected Loss)

In further embodiments, the value at risk for data files in an enterprise is used to estimate the average annual risk (or expected loss) for a specific computer, department or the enterprise. This average annual risk is the expected loss each year from any indicated components of cybersecurity incidents, represented in monetary value. In this discussion, risk (expected annual loss) can refer to the risk associated with a specific data file, data cluster, computer, or department; or the entire enterprise. As used herein, “expected” generally refers to the standard mathematical expectation or theoretical average “loss”, where “loss” is a random variable. Such estimates may also include estimates for the distribution of annual risk, recognizing the uncertainties of each component of the estimation methodology. In doing so, various methods for combining dependant random variables may be used. According to specific embodiments, these methods can provide advantages because the standard methods for computing the variance of an average, for example, tends to decline with the square root of the number of random variables averaged. This could create an estimate of uncertainty that is inappropriately low.

In specific embodiments, for simplicity, the risk for the enterprise, department, or sub-department is calculated by summing the risk for each computer within the enterprise. In other embodiments, the risk for the enterprise differs from the sum of the risks associated with each computer of the enterprise. For example, if a cybersecurity incident involves two computers, both of which contain copies of the same data files or documents, summing the risk for each computer would double count the loss from having this data file compromised. The opposite could occur, where two data files each contain information essential to understanding the other. In such cases, the loss might be negligible if either data file was compromised while the other was still secure. Other embodiments of this invention can estimate and adjust for these and other effects. Examples are further described herein.

Specific embodiments of systems and methods as described herein provide methods and/or systems for assessing Expected Loss Risk over a communications network. An important application for the present invention, and an independent embodiment, is in the field of providing security assessments over a wide area network or the Internet, optionally using Internet media protocols and formats, such as HTTP, RTTP, XML, HTML, dHTML, VRML, as well as image, audio, or video formats etc. However, using the teachings provided herein, it will be understood by those of skill in the art that the methods and apparatus of the present invention could be advantageously used in other related situations where users access content over a communication channel, such as mobile telephone systems, institution network systems, wireless systems, etc.

The general structure and techniques, and more specific embodiments that can be used to affect different ways of carrying out the more general goals are described herein. Although only a few embodiments have been disclosed in detail herein, other embodiments are possible and the inventor(s) intend these to be encompassed within this specification. The specification describes specific examples to accomplish a more general goal that may be accomplished in another way. This disclosure is intended to be exemplary, and the claims are intended to cover any modification or alternative, which might be predictable to a person having ordinary skill in the art.

The inventors intend that only those claims which use the words “means for” are intended to be interpreted under 35 U.S.C. 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running operating systems such as Windows, Linux, or Macintosh. The computer may also be a handheld device, such as a PDA, tablet, cellphone, Point of Sales systems, or laptop. The programs may be written in C or Python, Julia, Go, Rust, or Java, Brew or any other programming language. The programs may be resident on a storage medium, e.g., magnetic, solid state, or optical, e.g. the computer hard drive, a removable disk or media such as a memory stick or SD media, wired or wireless network based or Bluetooth based Network Attached Storage (NAS), or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20% or substantially more, while still staying within the teachings of the present application, unless some different range is specifically mentioned. Where a specified logical sense is used, the opposite logical sense is also intended to be encompassed.

Various specific embodiments provide methods and/or systems for cybersecurity assessment that can be implemented on a general purpose or special purpose information handling appliance or logic-enabled system, such as a laboratory or diagnostic or production system, using a suitable programming language such as Java, C++, C#, Cobol, C, Torch, Pascal, Fortran, PL1, LISP, assembly, etc. and/or a suitable numerical or data analysis language such as R, Sage, SPSS, MATLAB, Octave, Juila, and Python; and any suitable data or formatting specifications, such as HTML, XML, dHTML, TIFF, JPEG, tab-delimited text, binary, etc. In the interest of clarity, not all features of an actual implementation are described in this specification. It will be understood that in the development of any such actual implementation (as in any software development project), numerous implementation-specific decisions must be made to achieve the developers' specific goals and sub-goals, such as compliance with system-related and/or business-related constraints, which will vary from one implementation to another. Moreover, it will be appreciated that such a development effort might be complex and time-consuming, but would nevertheless be a routine undertaking of software engineering for those of ordinary skill having the benefit of this disclosure.

The disclosed methods can be implemented using concurrent computing, where processes run on multiple processors, processes use multiple threads, or computations are performed using wholly or partially with additional hardware FPGA, graphics cards using programming languages such as CUDA or OpenCL, or other parallel computing hardware. In some embodiments, the methods are performed using distributed computing and a network of computers employing MapReduce implementations such as HADOOP or other distributed file system architecture.

In some embodiments, methods are provided wherein cybersecurity incidents are categorized based on different cybersecurity incident types (e.g., exemplary cybersecurity incident types shown in Table 2), and the different types of data compromised (e.g., exemplary data types are shown in Table 3). This categorization scheme allows for the characterization of the rate of cybersecurity incidents by incident types, characterization of the value of data types and the value at risk for different incident types as those affect different to data types. Note that some cybersecurity incident types, for example a Denial of Service Attack on an online market place, may impede the function of a computer system rather than result in the theft of data. Additionally, the value at risk for the various data types can further depend on the intention or skill of a perpetrator.

TABLE 2
Cybersecurity Incident Types

| Incident Types | Description |
|---|---|
| Lost computer | A computer that was lost, stolen or misplaced. Examples include a laptop left in a |
| | taxi or a smartphone stolen from a car. |
| External | The loss of proprietary or other information by an external entity or agent, for |
| Espionage | example a competitor or foreign state. |
| Internal | The loss of proprietary or other information by, an internal agent, for example, an |
| Espionage | employee or service provider. |
| APT (Advanced | The loss of proprietary or other information, typically by an external entity or |
| Persistent | agent, over a prolonged period of time, e.g., long term espionage incident, |
| Threat) | generally thought of a malicious software, but according to specific embodiments |
| | can include compromised employees. |
| Destructive | Software placed on a computer or computer system that destroys, corrupts, or |
| malware | otherwise makes unavailable data to a user. For example, ransomeware, that |
| | encrypts data rendering it inaccessible or destructive malware that re-formats hard |
| | drives, thereby destroying data. |
| Denial of Service | A cyber attack that makes a public facing cyber resource unavailable to the public |
| | or clients, for example, an online marketplace or a VOIP phone system. |

TABLE 3
Data Types

| Data Type | Description |
|---|---|
| Custodial | Data that enterprises are compelled to follow-up with, |
| | when breached. Examples include: Personally Identifiable |
| | Information (PII), credit card information, patient |
| | records, account names, and passwords. |
| Proprietary | Data that enterprises want to keep secret for competitive |
| | reasons. For example, client lists, products under |
| | development, or trade secrets. |
| Third Party | Proprietary data of an enterprise's business partners or |
| | clients. |
| Public | Data that could damage the enterprise's public reputation. |
| Relations | |
| Operational | Data that characterize the financial value of a infra- |
| | structure component that must remain functional for |
| | operations within an enterprise. Examples, might include an |
| | online market place or an internal database used for |
| | processing orders. |

For the purposes of estimating the cost or impact associated with compromise of particular computers, systems or data, according to specific embodiments, data stored in the enterprise is classified into two data categories: structured data and unstructured data. Structured data is data that is located in databases and database files such as database backups, typically as queryable tables of records that may include different fields. Unstructured data comprises all other types of data including text documents, slide presentations, spreadsheets, portable document format (PDF) files, etc. Note that some data files, such as spreadsheets, can be categorized as structured or unstructured data, depending whether the records or rows in the spreadsheet are to be individually analyzed in terms of cost. For simplicity, however, spreadsheets not containing records defined by a larger enterprise data structure, are categorized as unstructured data.

### Automatically Discovering and Evaluating Cybersecurity Risk Values in an Enterprise

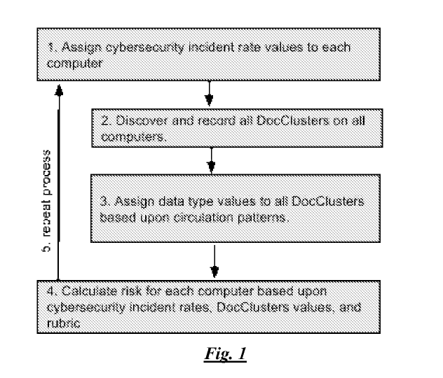

An example detailed method for scanning data in an enterprise, inventorying and evaluating that data, and determining calculating expected loss from cybersecurity risk from unstructured data within an enterprise is presented in FIG. 1. Further details, options, and variations on this example method are discussed in detail throughout this disclosure. In this example, rates for various cybersecurity incidents, such as those categorized in Table 2, are accessed or determined to various computers or computing devices in an enterprise. (FIG. 1, step 1). These rates may be determined internally to an enterprise, for example based upon the measured factors for each computer, or they may be based on industry data or norms or other initial values. As one example, rates may be expressed as incidents per year. Rates may be modified over time or adjusted based on the adoption of various mitigation policies.

Unstructured data is also discovered across the enterprise by consolidating information about data files found on each computer and optionally clustering data files into various clusters as discussed below. Generally, a history is maintained about data files and/or documents found on each computer (e.g., FIG. 1, step 2).

Values at risk are determined for data or data files or clusters. As discussed below, these values at risk can determined by human assessment, sampling, or other means and according to specific embodiments are extended to various data files and clusters based on circulation patterns in the enterprise (FIG. 1, step 3). According to specific embodiments, values at risk are determined or assigned as means and standard deviations for various data types as presented in Table 3.

Risk (or expected loss) values or random variables can then be determined for each computer (FIG. 1, step 4), for example as risk for each incident type and each data type. For example, if there were six incident types as in Table 2, and six data types as in Table 3, then thirty-six risk values would be calculated for each computer. In one example implementation, each risk value is calculated as discussed below, e.g., as shown in (Eq. 6.1a and 6.1b).

In specific example implementations, the steps in FIG. 1 are repeated periodically or continuously (FIG. 1, step 5), at a rate that captures significant changes in incident rate and documents across the enterprise.

### Clustering by File Contents (e.g., Identifying Unique Documents)

In one aspect, methods are provided for clustering data according to contents and/or other data or file characteristics. In some embodiments, a first level content clustering of data is referred to as a unique document or simply a document. A document as used herein is a cluster of data having substantially similar or identical or nearly identical content. Often, data or data files clustered into a document comprise different versions of essentially the same data. A document therefore may be understood as a cluster or group of electronic files that were jointly created, modified or edited by multiple persons, or electronic files that are shared across one or more departments within an enterprise or shared between two or more enterprises. Thus, according to specific embodiments, all unstructured data files or subsets thereof are inventoried and clustered into documents based on their content or summaries their of content such as word histograms. In specific embodiments, data file contents or their summaries can be further refined by filters that remove specific words such as stopwords, pronouns, articles, punctuations, and rare words. In further embodiments, meta-data, such as file size, check-sum, creation date, and last modification date, may be taken into consideration in the process of clustering data into particular documents. According to specific embodiments, methods and systems of the invention store information about identified unique documents such as a record of every electronic file associated with the document and when particular electronic files resided on a specific computers and when and by whom the electronic files were accessed or created or modified. Thus, depending on the context, a document is a collection of many different individual electronic files that are identical or substantially identical in terms of their content

### Clustering Documents by Circulation Patterns

In most enterprises, participants (e.g., employees, academicians, students, etc.) generate and share data files within and between departments. A subset of data files will circulate between departments. Many different kinds of data files circulate within an enterprise, some of which are shared across most enterprises, e.g., expense reports, while others may be more industry or organizationally specific, e.g., patent applications or clinical trial reports. When employees within their respective department carry out a specific set of tasks, they read and generate data files that have similar properties. For example, if someone in the legal department drafts a contract then emails this draft to a coworker in the business development department who makes modifications, these two data files would be grouped as a single unique document for purposes of value at risk analysis.

According to specific embodiments, unique documents, which can be considered a first level clustering of data files, are further clustered into one or more additional levels of clusters to facilitate cybersecurity risk assessment, such as value at risk analysis. Thus, value at risk clustering clusters data items based on various shared or similar characteristics that are believed to indicate documents with similar or identical value at risk. One specific second level clustering of data according to specific embodiments is termed a “circulation pattern.” A circulation pattern describes the existence or movement of data between the computers of an enterprise. According to specific embodiments, circulation patterns are identified that indicate documents having similar value at risk to the enterprise. These circulation patterns can be expressed as lists of computers, groups of computers, or departments within the enterprise where a particular document is or has been found.

In further embodiments, generally for efficiency reasons, circulation pattern clusters can be imported from other enterprises, particularly those enterprises in the same or similar line of business, or from a library of circulation patterns. Therefore, for example, it may be predetermined that one important circulation pattern is Sales Department, Publication Department, and Accounting Department and another important circulation pattern is Legal Department and Upper Management. Thus, documents or documents in a new enterprise that fall in these two circulation patterns can be evaluated together to determine value at risk for the documents.

While specific examples of first and second level clustering of data are described above, various other data characteristics can be used for automatically clustering data files either to create documents or value-at-risk clusters. For instance, data files can be clustered base on meta data such as a data file's author or originator, the data file's age, length, or number and variety of revisions made to the data, the number and/or frequency of words in a data file that appear in key word lists, the number and/or frequency of the usage of the names of key personnel, clients, customers, or government entities, data type, e.g. custodial data, etc. that appear in a data file. In further embodiments, the value at risk clustering of data files is performed using topic modeling. Numerous methods of topic modeling are known in the art, including Latent Dirichlet Allocation (LDA), Blei, Ng, and Jordan, 2003; Probabilistic Latent Semantic Modeling (PLSA), Hoffman, 2000; Random projection, Bingham and Mannila, 2001; Pachinko allocation model (PAM), Li and McCallum, 2006; and Hierarchical Dirichlet Process (HDP), Wang, Paisley, and Blei, 2011. In other embodiments, topic models can be imported from those used in other enterprises, particularly enterprises within the same or similarly field of business. In further embodiments, the clustering of data files is performed using patterns defined by regular expressions or using machine learning and statistical classification algorithms. Numerous methods include dimensionality reduction algorithms, correspondence analysis, Artificial Neural Networks, k-Nearest Neighbors, Support Vector Machines, and Naive Bayes. Such methods can be used to perform documenting on value at risk clustering according to specific embodiments.

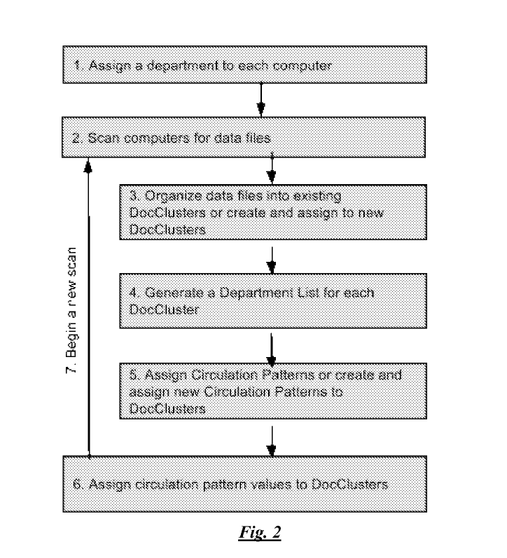

An example detailed program flow for determining a circulation pattern to each document or data or document within the enterprise is outlined in FIG. 2. FIG. 2 provides one example of performing steps 2 and 3 of FIG. 1. The example program flow begins by assigning a department or group or other identifier to each computer (FIG. 2, step 1), where the identifier assigned according to specific embodiments indicates the importance for the principal user of each computer in value at risk. In many instances, the identifier is the respective department of the user of the computer. For example, if the computer is a workstation that belongs to an employee in the Human Resource (HR) department, then the identifier assigned to the computer would be the HR department. In most companies, a list of computers and their respective departments might be generated from an HR-Management system or by combining output from an HR-Management and an IT-Asset-Management system. Some computers, such as the CEO's or those belonging to specific key employees, can be assigned a unique identifier for purposes of determining circulation patterns.

The program flow continues by initiating a scan cycle, where all computers are scanned for unstructured data such as text documents, slide presentations, spreadsheets, and PDF files (FIG. 2, step 2). In certain industries, unstructured data may include other types of data files such as software source files. The process of scanning unstructured data includes reading the file name, file check-sum, word histogram, computer identifier, and recording the date and time that the scanning procedure was performed and location of the scanned file system for each data file. Data files might be remotely scanned on computers using Web-Based Enterprise Management or the Common Information Model standards.

After all data files are scanned, they are organized into value at risk clusters such as described above (FIG. 2, step 3). Various methods for deciding which data files belong to the same unique document are discussed herein. Data files can be organized into existing documents that were identified during previous scans or into new a new document if the data files do not correspond to any existing unique documents.

Once the unique documents are identified, generally all data files belonging to a unique document are analyzed to determine a value at risk cluster (e.g., circulation patterns) of the document. In the case of circulation patterns, if the document's circulation pattern matches a previously identified and stored circulation pattern entry, then the value at risk random variable of the existing circulation patterns is assigned to the document. If the circulation pattern of the document is new (e.g., not correlated with any previously existing circulation patterns) then a new circulation pattern value at risk cluster is created and default mean and standard deviation value at risk values are assigned for each data type. Specific example method for updating of mean and standard deviation values for circulation patterns according to specific embodiments is further described below. Generally, the number of documents assigned to a circulation pattern will grow over time, as documents are created within the enterprise. In addition, during a document's life cycle, it may be assigned to different circulation patterns as its circulation pattern changes or develops.

According to specific embodiments, the process for scanning data files is repeated periodically or continuously (FIG. 2, step 7) to capture any changes to data within the enterprise. The circulation pattern for a document may develop over multiple scans cycles, as the first draft of a data file is created, then revised by a another person, or circulated to people who read then delete the data file. A circulation pattern according to specific embodiments therefore constitutes all locations (computers or computer groups) where a document ever appeared over multiple scans.

Constructing an inventory of all data files in an enterprise as described above may take substantial amounts of computer time, particularly for large enterprises. Fortunately, approximations of an inventory may be obtained in a substantially shorter period. Approximations are particularly useful for initial planning purposes. Approximations can be facilitated by standard sample survey tools routinely used in the art. These tools include, but are not limited to, random sampling, multi-stage stratified cluster sampling and sampling based upon pseudo-random numbers, optionally employing techniques like importance sampling with cluster or stratified sampling or other techniques common among sample survey practitioners.

### Sampling Unique Documents in Clusters

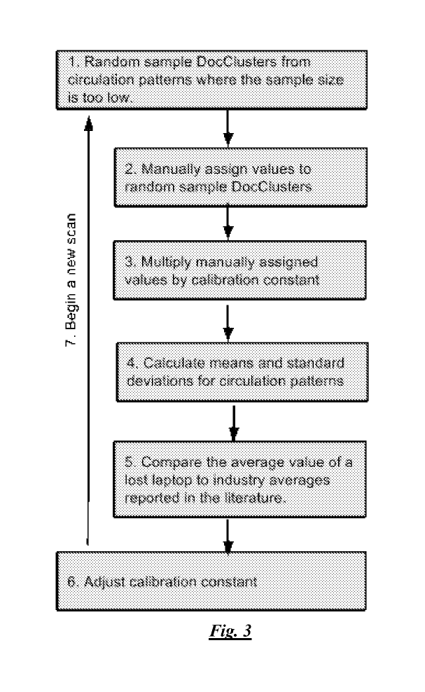

In the example above, data files are grouped or clustered or characterized as belonging to a set of unique documents. However, in many enterprises, it will not be practical or possible to individually determine a value at risk random variable for each document. Therefore, according to specific embodiments, the unique documents are further clustered into value at risk clusters, such as circulation patterns. Once circulation patterns are identified and each document is associated with a circulation pattern, systems and methods as described herein then determine value at risk expressions for each circulation patterns. An example method for assigning value at risk, including mean and standard deviation values is shown in FIG. 3. This method can run independently of other program flows, but may be most efficiently run after several cycles of the main program flow (FIG. 1) has executed so there is a sufficient number of circulation patterns and assigned documents for sampling. This program flow begins (FIG. 3, step 1) by randomly choosing one or more documents as samples for the most common circulation patterns. According to specific embodiments, the number of random samples chosen may be a function of the standard deviation values and the number of random samples previously chosen, so there will be sufficient random samples to accurately characterize the value at risk as a random variable for the circulation pattern. Optionally, zero random samples are selected for circulation patterns that are indicated already sufficiently characterized. Various numbers of random samples can be chosen according to specific embodiments for new and yet uncharacterized circulation patterns that have previously had default standard deviation values assigned (see FIG. 2, step 5 above).

The program flow proceeds (FIG. 3, step 2) with the computer program determining value at risk for each randomly sampled document, for example by presenting each randomly sampled document to an evaluator to assign, optionally for each data category found in Table 3, a minimum and maximum value at risk and optionally assign other related values (e.g., confidence or uncertainty of the values assigned) to the sample. For simplification, this value at risk value is optionally not necessarily a dollar amount, but is a comparative value, for example from a scale of 0 to 10 (which can represent various step-wise or logarithmic levels of comparative risk). According to specific embodiments, the computer program can present a randomly sampled document to the expert by reading and displaying the contents or summary of the contents of a specific data file in the cluster (for example the most recently modified or most frequently accessed data file) on a computer screen or other display. The computer program can locate and read a specific data file associated with a unique document because computer identifiers, file names, and file system locations are recorded for each data file associated with a unique document.

In some embodiments, an evaluator can assign a minimum and maximum value range based upon the kind of document, rather than the value of the specific document being reviewed. For example, if the document is a patent application then the minimum and maximum values might reflect the range for all patent applications. According to specific embodiments, the “kind” determination may be performed by the human expert or by various automated document analysis methods, such as topic modeling. According to specific embodiments, value at risk values for a document or document or data may be determined according to document type, circulation pattern, topic modeling or any combination thereof.

### Using Random Variables to Express Loss

According to specific embodiments, methods and systems as described herein express loss or expected loss from cybersecurity incident(s) as a combination of at least two different probabilities (or random variables), one primarily representing the probability that an incident will occur and the other representing the variable value at risk for a particular enterprise component (e.g., a document or a laptop). Incident probabilities (e.g., probability of a lost laptop) are familiar in the art and are often published for various types of incidents. The probabilities can be expressed easily for some types of incidents, e.g., the rate of laptop loss or the probability that any given laptop in an enterprise will be lost or stolen is 2% per year.

According to specific embodiments, a random variable is used to express value at risk because in a typical enterprise, unstructured data exists in various files on various computer systems throughout the enterprise. Many of these files if lost or compromised, would not be associated with any risk of financial or other loss to the enterprise. Examples would be data that is otherwise publicly available, like brochures, press releases, etc., intended for public access. Other files would have some potential cost to an enterprise if the data were compromised. Some of these costs are known and generally fixed. Other of these costs are not specifically known, but can be estimated as a probability or random variable. Loss of customer credentials for 100 credit cards, for example, might be associated with a fixed cost of changing the credit card numbers for the customers (e.g., $10 per card), and a certain but variable cost to the enterprise of its reputation or trust (e.g., a public relations cost of $10,000 per incident that is made public, adjusted by some expression for the number of cards lost.) The compromise could further result in losses due to fraudulent charges. Note that this cost could be $0 if there are no successful attempts to fraudulently use the numbers or could be up to the maximum charge limit per card, which could be a range of, for example, $500 to $10,000 per card. Note that the variability in the possible losses discussed in this paragraph are independent of the probability of a cybersecurity incident occurring. Thus, according to specific embodiments, value at risk is expressed as a random variable. To address this cost variability systems and methods according to specific embodiments determine a value at risk expression generally for specific data items or clusters of data items (e.g., file or structured data entry) in the enterprise.

The value at risk, according to specific embodiments, can be expressed in various statistical random variable forms. Value at risk expresses the financial loss for an enterprise from a particular cybersecurity incident (e.g., loss of a computer).. This is sometimes also referred to as “potential impact” of an incident by cybersecurity experts. Value at risk could be, for example, all of the costs resulting from an incident, including reputation damage and lost customers, investigation costs, notification costs, and future legal expenses, or the loss in competitiveness and market share resulting from the cyber-theft of proprietary information. Value at risk also may include 1) loss revenue or loss productivity from a denial of service attack or a service disruption attack, 2) costs related to ransomware and other types of cyber-extortion.

Value at risk generally is expressed as it relates to specific data, document, document cluster, or computer or group of computers. Value at risk can generally be characterized by a positive random variable Y or a positive random vector, Y, of values for multiple data types, clusters, computers or departments. According to specific embodiments, a subscript i as Yᵢ is used to denote a vector of value at risk for, e.g., different data types in a cluster (or in a computer or a department) i. (This discussion at times uses the standard notational conventions in the statistics literature that scalars are italicized, such as Y, vectors are set in bold, such as Y. Often, though not always, random variables or vectors are capital letters, and non-random quantities are lower case, like i. However, this convention is not followed in all cases, as witnessed by the use of R to denote expected loss, which is not a random variable, and F to denote a matrix presumed to be nonrandom (in most embodiments). The use of the notations in context will be understood to those of ordinary skill in the art.)

Data files or records or documents or clusters can contain multiple types of data, with the value at risk dependent on the data type. For example, a spreadsheet of clinical trial data from a pharmaceutical company might have both a high proprietary value, e.g., clinical trial results, and high custodial value, e.g., patient identification and medical records, but little or no third party data value. Thus, a value at risk calculation method can estimate a value at risk of a document separately for the different types of data the document contains.

Determining an accurate, useful, and rigorous value at risk for enterprise components (e.g., particular data files, documents, clusters, computers or groups of computers) is difficult. While it would be perhaps desirable to have a human expert assessment of the value at risk for individual data files, this is generally impossible in any but the smallest enterprise. Thus, various novel approaches to determining value at risk for data, computers, systems, and groups are employed in systems and methods according to specific embodiments.

### Incident Rates

Incident rate data can be obtained by various methods, for example, from published incident rates, from calculations using raw data published by governmental or other entities, or from rates determined for a particular enterprise, etc. For convenience in this discussion, it is assumed rates are recorded as incidents per year.

### Incident Rate (or Risk) Modefilm Adjustments

The risk from a cybersecurity incident of data loss is a function of many factors, some of which can be controlled by management strategies and policies. According to specific embodiments, incident rate (or risk) adjustments modeling adjustments (sometimes referred to as adjustments) can be added to the probabilities of cybersecurity incidents for information believed to be relevant. Incident Rate/Risk Modeling Adjustments (IRMAs) can include values found on a look-up table, derived from equations, derived or calculated from published sources, read from streaming feeds from databases, etc.

IRMA's as discussed herein can include one or more of:
1) Characteristic from the company such as number of employees, the number of user with access to a computer network, the industry classification of an enterprise, countries in which the organization operates;
2) Software and cybersecurity management policies such as an antivirus program, authentication levels for a computer, anti-phishing training, firewalls, and operating systems;
3) Physical devices such as locks, type of computer, and storage devices; and
4) Similar or related factors.

According to specific embodiments, IRMA's can be assigned to individual computers, types or classes or computers, departments, etc. These adjustments may be additive in an appropriate transform space such as logits, probits or other inverse cumulative distribution function.

### Occurrence of Cybersecurity Incidents as a Random Variable

According to specific embodiments, the occurrence of a cybersecurity incident is represented by a zero-one (Bernoulli) random variable U, or a multivariate Bernoulli U. (Bernoulli probabilities can be related to incident rates using, e.g., the standard Poisson model. With this assumption, the probability of at least one incident p=1−exp(−λ), where λ is the incident rate or the expected number of incidents in the time period of interest.)

### Scaling Factor (F) Representing the Fraction of Data Compromised

According to further specific embodiments, the value at risk determined or calculated or estimated for data is modified according to generally incident specific characteristics. As an example, a data file containing proprietary technical or business data, particularly in a non-standard format, (such as a CAD or design file for a proprietary circuit design or chemical compound or a secret bid file for a contract) is more likely to have a very high cost associated with it if it is compromised as a result of industrial espionage loss value than if it is lost as a result of a lost laptop. Thus, while the estimated value at risk for the file is might be high, this can be adjusted according to the type of incident in which the file is compromised.

In some embodiments, a scaling factor, F or F being a matrix of scaling factors, with a range of 0 to 1 may be used to modify the rate of occurrence of a cybersecurity incident. The scaling factor is used to represent the fraction of data compromised during the incident where a cost is incurred. The scaling factor can be empirically derived or calculated from a function and represents the fraction of data compromised during the incident.

The scaling factor can also account for the probability that the compromised data will be used in such a way as to incur a cost. For example, in the case of a lost or stolen laptop, it is unlikely (but not a zero probability) that an unauthorized person will have the ability or motivation to utilize the proprietary data on that computer and so the value of constant F will generally be estimated or determined to be small for proprietary data. In the case of custodial data, even if the person is unlikely to have the ability to utilize the data, the enterprise may have an obligation to notify concerned parties that data has been potentially exposed and so F may be 1 for custodial data.

### Combining F and U

A modified version of the occurrence of a cybersecurity incident is represented with V or V, where it is a variation of the product of F and U as shown in the following examples:

V=FU and V=F′U

In different embodiments V or a vector or matrix V is a scaled Bernoulli scalar random variable or vector; this makes it a random a variable from 0 to 1 representing a fraction of the value at risk compromised; if the proportion, F is 1, then V or V follows a (multivariate) Bernoulli distribution. These embodiments are discussed in the sections below.

### Expected Loss

Expected loss from a cybersecurity incident is expressed as a random variable (or in some cases a random vector) being a sum of products of the incident random variables U or V. multiplied by a random variable (Y) expressing value at risk in the incident. According to specific embodiments, expected loss is calculated as a random variable or vector Z, with a probability distribution. In some embodiments, the expected loss in a given period of time (e.g., a year) can be expressed as the sum of products of random variables or random vectors indicating the different types of cybersecurity incidents multiplied by the random losses associated with data that is compromised in an incident of the corresponding type.

### Adjusting Loss Based on Relationships or Correlations of Compromised Data

For a given computer or computer system, the loss from a cybersecurity incident will be related to the losses associated with the data files compromised in the incident. This can be estimated as the sum of the (random) losses associated with the individual data units (e.g., documents or documents) that appeared or were accessible by that computer or system for any portion of the duration (Δt) of the incident. Other embodiments may estimate higher or lower numbers. According to specific embodiments, a sum of loss for files on a compromised computer is adjusted in accordance with the relationships of the data compromised. For example, if 80 percent of the contents of files A and B are identical, and the loss of each is estimated at $1 million, the loss of both may only be worth $1.2 million rather than $2 million. Alternatively, if a system design worth $10 million is described in two files, e.g., both of which are necessary to reveal the design, and only one is compromised, the loss can be negligible if the other file remains secure.

### Adjusting Loss Based on Duration of Incident

The probabilities of different types of cybersecurity incidents occurring in a given time frame involving a particular computer or collection of computers may be estimated and modeled using a variety of published sources.

Since the data on a computer changes over time, the loss from a cybersecurity incident can be a function of its time and duration. In some embodiments, risk estimates are calculated without considering the duration of incidents but only the number of unique documents compromised in a particular incident, e.g., by being on a compromised computer any time between installation of spyware and its discovery and removal.

In other embodiments, expected loss risk estimates are approximated by multiplying the value at risk at the time the incident was discovered by some function of the duration, Δt. For example, a lost laptop exposes the full value of custodial data found on the laptop when the laptop was lost, but generally only a fraction of the value of proprietary data. Similarly, an APT will expose the full value of custodial data and because of the intent of the perpetrator, a substantial fraction and perhaps all of the proprietary data that ever appeared on a computer during the period for the APT (typically a year).

### Loss as a Product of Scalar Random Variables

According to specific embodiments, loss is expressed and estimated as a random variable that is 0 when there is no cybersecurity incident and some positive value when there is an incident. The Loss Z can be modeled using:

Z=VY

where
V is a random variable as described above;
Y is the value at risk, a positive random variable representing the random loss when a cybersecurity incident occurs, possibly with subscripts that represent specific aspects.

In some embodiments, it is assumed that the loss Y follows an absolutely continuous probability distribution on the real line representing the value at risk to the enterprise of having that document compromised in the designated way.

### Scalar Loss as a Product of Random Vectors

In some embodiments, the random variable for loss Z can be calculated from a product of random vectors.

Z=V′Y.

where
V is a vector of Bernoulli random variable;
Y is the value at risk, a vector of positive random variable representing the random loss when a cybersecurity incident occurs.
(′) denote the transpose function

### Loss as a Vector

In some embodiments, loss can be represented as a vector of random variables. Alternatively, a vector Y of losses given incidents indicated by a vector V, the total loss is Z=V′Y, where prime (′) denotes transpose, the loss for each component of Y is Z=bdiag(V′)Y,

where:
V is a vector representing the occurrence of cybersecurity incidents.
Y is a vector with vectors of losses given incidents indicated by a vector V
bdiag(V′) is a block diagonal matrix whose nonzero blocks are given by subvectors of V.

In some cases, the components of Y represent the losses associated with different information from different data types in a given document. More generally, Y can be a large vector with subvectors Yᵢ containing the loss for each data type in document i. In such cases, V would be a vector with subvectors Vᵢ, and the loss would be represented by Z=V′Y=ΣVᵢ′Yᵢ.

For example, suppose V=(a1=V₁, a2=V₂, b=V₃) where a1 and a2 are two devices in department “a”, and b is a device in department “b”. Then bdiag(V′) can be defined as a 2×3 matrix of departments by device as shown in Table 4.

TABLE 4
Exemplary matrix

| | | |
|---|---|---|
| V₁ | V₂ | 0 |
| 0 | 0 | V₃ |

In this way, bdiag(V′) is defined to produce partial sums for any partition of VⱼYⱼ that might be of interest.

### Fraction of Value at Risk Compromised

In other embodiments, value at risk V represents a fraction of the value at risk compromised in a cybersecurity incident. V may be 0 when there is no incident and a positive number, at most 1, when an incident occurs, with V representing the portion of the value at risk, Y, actually compromised in a particular incident.

For example, if the incident is a lost computer, the value actually lost may be considerably less, e.g., 20%, of the value lost in a spyware incident. In this case, V could be 0.2 for a lost computer and 1 for spyware. By extension, V would represent a random vector of such values.

In some such embodiments, V can be the product of a factor multiplied by a Bernoulli random variable:

V=FU,

where
F is a scaling factor, with a range 0≦F≦1.
U is a Bernoulli random variable.

A random vector V, can be represented as V=F′U, for an appropriate matrix F, where 0≦F≦1 (i.e., each element of F is between 0 and 1). Suppose U is a Bernoulli random vector for incident types impacting a particular document and F related incident types to data types as described with Table 5. If at most one element of U is 1, then 0≦V≦1.

For example, a more general case with F₁ being a 2×3 matrix as described with Table 5 mapping incident types to data types. Consider 3 computers with 3 documents. Suppose document_{—}1 is found on all 3 computers, document_{—}2 is only on the first computer and document_{—}3 is on the second and third computers but not on the first, as indicated in the following table:

TABLE 5

| | document_1 | document_2 | document_3 |
|---|---|---|---|
| computer_1 | 1 | 1 | 0 |
| computer_2 | 1 | 0 | 1 |
| computer_3 | 1 | 0 | 1 |

Then the matrix F is a 6×9 matrix being a 3×3 array of 2×3 submatrices as follows:

$$\underline{F =} [ \begin{matrix}\underline{{F}_{1}} & \underline{{F}_{1}} & \underline{0} \\ \underline{{F}_{1}} & \underline{0} & \underline{{F}_{1}} \\ \underline{{F}_{1}} & \underline{0} & \underline{{F}_{1}}\end{matrix} ]$$

In this example, spyware that infects one computer could easily infect the others. In such cases, some components of V=F′U may have a non-zero probability exceeding 1. In some embodiments, this can yield a rate that is further used in calculations. In other embodiments, the users may consider that the value at risk Y may not be lost more than once. In the latter case, V=f(F, U) where f(F,U) is the matrix product previously described clipped at 1 when the product otherwise exceeds 1.

### Random Loss as a Zero-Inflated Random Variable

In the following, modeling the probability distribution of the value at risk, Y, the probability distribution of different cybersecurity incident types impacting multiple computers, and the distribution of the resulting loss. In some embodiments, the loss 4 is decomposed into a combination of an indicator of the presence of cybersecurity incidents U and the loss Y, in different data types. For convenience, it can be written as follows:

Zᵢ=Uᵢ′FᵢYᵢ, Eq. 1
where Uᵢ=a random vector of 0's and 1's indicating the type(s) of cybersecurity incident(s) impacting the entity of interest (e.g., department or computer or document i), so each component of Uᵢ corresponds to a different incident type,
Yᵢ=a random vector of the losses anticipated in different data types, so each component of Yᵢ corresponds to a different data type,
Fᵢ=an operator converting the random vectors Uᵢ and Yᵢ into the scalar random variable Zᵢ,
   and prime (′) denotes transpose, so Uᵢ′ denotes the row vector being the transpose of the column vector Uᵢ.

In some embodiments, Fᵢ is a matrix and Uᵢ′FᵢYᵢ is the standard matrix product of a row vector multiplied by a matrix time a column vector. However, a person of ordinary skill with nonlinear operators could generalize this to nonlinear operators possibly considering other information suppressed here for notational convenience.

Without loss of generality it is assumed that Uᵢ and Yᵢ are statistically independent, though Uᵢ and Uⱼ may be dependent on one another and Yᵢ and Yⱼ may be dependent on one another for i not equal to j. [The essential generality of assuming Uᵢ and Yᵢ independent stems from the fact that Uᵢ assumes only the values 0 and 1, which means that (Yᵢ|Uᵢ=0) can be defined arbitrarily without affecting the values of Zᵢ.]

Approximations considering dependence are further described herein; these approximation should be adequate for many of the purposes considered here, especially given other limitations of the available empirical evidence. A person of ordinary skill with dependent random vectors could easily generalize this to handle any number of other kinds of dependencies between random vectors. If simple formulae are not readily available, Monte Carlo methods can support computation of any quantity of interest and the development of other approximations.

In some embodiments, 1′U=1, where 1 denotes a column vector of all 1's, so 1′U denotes the sum of all the components of the column vector U. In such embodiments, the first component of U will typically be 1 for outcomes with no cybersecurity incident. In other embodiments, this outcome is omitted from the vector U, so 1′U is 0 for such outcomes and 1 otherwise. The other components of U correspond to outcomes involving any combination of incident types with a non-negligible probability of occurrence. For example, with two incident types, lost computer and spy-ware, U could have only two components if the outcome with no cybersecurity incident is omitted, and the outcome with both a lost computer and spyware having negligible probability. Alternatively, it could have four components, representing (a) no cybersecurity incident; (b) a lost computer; (c) spyware; and (d) a lost computer with spyware. With k possible incident types, the dimensionality of U would be at most 2^{k}.

With this, U follows a multivariate Bernoulli distribution with expectation E(U)=u, with 1′u being at most 1.

### Correlated Losses

In other embodiments, a zero-inflated log normal can be used to approximate the loss distribution. It is unrealistic to expect that Zᵢ and Zⱼ will be statistically independent for i not equal to j. This follows for at least two reasons: (1) First, a cybersecurity incident that extracts a higher than average value from one department, computer or document might also extract a higher than average value from another; (2) Second, biases in the estimation of the value of one document will likely impact other documents as well.

In some instances value at risk can be represented by a multivariate log normal distribution, which includes combining different estimated log normals for the same document and combining the information across documents with the same or equivalent circulation patterns. The mean for the multivariate log normal is determined by:

E(Y)ⱼ=exp(νᵢ+τᵢᵢ/2)

and the covariance matrix by:

var(Y)ᵢⱼ=exp[+νᵢ+νⱼ+(τᵢᵢ+τⱼⱼ)/2][exp(τᵢⱼ−1)]

where ν is the mean of the logarithms and τᵢⱼ is the (i, j) element of the covariance matrix of the logarithms.

To discuss this further first Z is defined as (Zᵢ, Z₂, . . . )′=a column vector of random losses for different documents on or previously accessed from a given computer or within a given department or enterprise. Let cov(Z|Z>0)=S=the covariance matrix of Z conditioned upon the event that at least one component is positive.

S=diag(s)Cdiag(s),

where

s=the column vector of standard deviations from S

diag(s)=the diagonal matrix with s as its diagonal, and

C=the resulting correlation matrix.

The simplest nontrivial correlation matrix is C=(1−c)I+c11′, for appropriate values of c. Then

var(1′Z|Z>0)=[s′s(1−c)+c(1′s)²],

where (Z>0) is the event with at least one element of Z being positive.
As a check, consider the simple case where s=1=a vector of all 1's. If the dimensionality of Z is n, then var(1′Z|Z>0)=n(1−c)+cn²:
If c=0, var(1′Z|Z>0)=n; this is expected assuming zero correlation.
If c=[−1/(n−1)], var(l′Z|Z>0)=0. Of greater concern is when c is positive, as then var(1′Z|Z>0) grows with n²; when c=1, var(1′Z|Z>0)=n².

This is mentioned because the central limit theorem says that the distribution of a sum of independent random variables will be nearly normal than the distribution of the individual summands (assuming the individual summands have finite variance). However, that may not be true with dependent random variables. The above formula for var(1′Z|Z>0) establishes that by assuming that all Zᵢ's have the same positive correlation, var(1′Z|Z>0) will grow with n² not just n—and other aspects of the distribution may not behave as one would expect from independent random variables.

The discussion to this point has not assumed a distributional form for Yᵢ, Zᵢ, or 1′Z apart from assuming finite variance. In some embodiments, it is convenient to assume a multivariate log normal distribution for Yᵢ. This is consistent with the observations that the distribution of financial values that must be positive is often closer to log normal than normal. Note that the market price of many financial instruments can often be thought of as the accumulation of many small percentage adjustments. This in turn suggests that the central limit theorem would more likely hold on the log scale where percentage adjustments become transformed from multiplicative to additive; when this happens, the central limit theorem may apply on the log scale to produce a distribution well approximated by a log normal.

With this logic, it is convenient in some cases to approximate the distribution of 1′Z given Z>0 by a log normal distribution with variance matching the value for var(1′Z|Z>0) for some appropriately chosen level of correlation, c. Alternatively, when deeper understanding of the distribution of the distribution of 1′Z given Z>0, Monte Carlo simulations could be used with different plausible assumptions for the level of correlation.

### Incidents by Type

Let U be the vector indicating the occurrence of cybersecurity incidents, with component Uᵢ denoting the occurrence of a specific type of incident impacting a particular document, computer, or department. Then the mean of U can be denoted as follows:

E(U)=p,

where E( . . . ) denotes the standard mathematical expectation of random variables, i.e., the sum or integral of probability (density) multiplied by the associated values of a random variable; pᵢ denotes the probability that Uᵢ=1; i and j denotes a specific combination of document, data type, and cybersecurity incident classification, and

Similarly the expected value of co-occurrences can be written as follows:

E(UU′)=P.

where P denotes a matrix of probabilities p_{i,j}=E(UᵢUⱼ).

The elements of P, p_{i,j} have the following properties:
1) p_{i,j}=0 if i and j are mutually exclusive (e.g., i=1 denotes a lost computer without any other incident impacting that computer in the indicated time period and j denotes any other incident)
2) p_{i,j}=pᵢpⱼ if i and j are independent
3) p_{i,j}=pᵢ=pⱼ if the occurrence of incident i (e.g. a particular incident type on a specific computer) virtually assures the occurrence of incident j (e.g., the same incident type on another computer tightly linked to the first), and vice versa.

The covariance matrix of U can be written as follows:

var(U)=P−pp′, where p=E(U), as above.

In some embodiments, a matrix F provides scaling factors relating data types within documents whose value at risk is Y to incidents denoted by U. Then the loss Z=U′FY. In other embodiments, a scaled incidents vector is defined as V=F′U with expectation and covariance as follows:

E(V)=q=E(F′U)=F′p.

var(V)=Q−qq′=var(F′U)=F′var(U)F=F′(P−pp′)F

Other embodiments, may clip V at 1 or many make other adjustments to avoid double counting the loss from an incident impacted a particular document. In such cases this is denoted more general operation by V=f(F, U) with the expectation and covariance matrix as follows:

E(V)=q

var(V)=Q−qq′

### Expected Loss (or Risk) Over a Particular Time Period or Other Range.

The expected loss for an enterprise or subcomponent as discussed below (or loss risk) can be expressed as:

R=E(Z), Eq. 3

Or for a vector or matrix of loss values

R=E(Z).

where:
R=risk in monetary value e.g., US dollars, for an enterprise, department or individual data file for a particular time period, e.g., a year;
E( . . . )=the standard mathematical expectation of random variables=sum or integral of probability (density) times the associated values of a random variable; and
Z=a random variable of the loss suffered in a cybersecurity incident(s) during the specified time period.

Note that “risk” as discussed immediately above is different from the “value at risk” discussed elsewhere. “Value at risk” is generally a term applied to particular data or data groups and indicates the financial impact on an enterprise if that data is compromised. Risk as used above is also sometimes used in the art to indicated the expected loss. Where “risk” appears separate from the expression “value at risk,” expected loss risk should generally be understood, unless the context indicates otherwise.

For some purposes, a subscript, e.g., i, is added to denote a particular department, computer, file or document.

$$R = {\sum }_{i}^{ } □ {R}_{i} ,$$

For example, the total risk R of an enterprise may be the sum over all departments or all documents on or previously accessed by a particular computer or accessible by employees of a particular department, and where i>1, Rᵢ denotes the risk for item i given R₁, . . . , Rᵢ₋₁.

Expected loss can be further decomposed in to components of the occurrence of a specific cybersecurity incident U or U and the value at risk Y or Y. Let pᵢ=the probability that Uᵢ=1, where a specific cybersecurity incident has occurred, as above. And let μᵢ=E(Yᵢ). Let us further assume that Uᵢ and Yⱼ are statistically independent, for all i and j, though Uᵢ and Uⱼ may be dependent, as may Yᵢ and Yⱼ, i≠j. Then E(UᵢYᵢ)=pᵢμᵢ and

R=Σpᵢμᵢ Eq. 4

Also, let p_{i,j}=the probability that UᵢUⱼ=1. And let σ_{i,j}=cov(Yᵢ, Yⱼ). Then E(UᵢUⱼYᵢYⱼ)=p_{i,j}(σ_{i,j}+μᵢμⱼ) and E(Z²)=Σp_{i,j}(σ_{i,j}+μᵢμⱼ). This assumes the scaling F is an identity matrix. If this is not the case, then appropriate adjustments must be made to these formulae.

Note that the sum in this expression for E(Z²) is actually a double sum. Next recall that var(Z)=E(Z²)−(EZ)². Then

var(Z)=Σ[p_{i,j}σ_{i,j}+μᵢμⱼ(p_{i,j}−pᵢpⱼ)] Eq. 5

As written, expressions (Eq. 4) and (Eq. 5) can be read assuming the Uᵢ's follow a multivariate Bernoulli distribution (Dai 2012) with probabilities of success for Uᵢ and UᵢUⱼ being pᵢ and p_{i,j}, respectively. If they follow a multivariate beta-Bernoulli, pᵢ and p_{i,j} can be replaced with the formulae for E(Uᵢ) and E(UᵢUⱼ) under the appropriate beta-Bernoulli formulae. This could involve assuming that (Uⱼ|Uᵢ) follows a beta-Bernoulli; if Uᵢ and Uⱼ are independent, then (Uⱼ|Uᵢ) would follow the same beta-Bernoulli as Uⱼ without knowledge of Uᵢ. This could be used for planning further sampling to achieve a certain reduction in variance for a budget or other instruments for financial analysis.

To understand (Eq. 5) better, consider a random vector (a vector random variables) Y=(y₁, y₂, . . . , yₙ)′, where the prime (′) denotes the transpose, which in this case converts a row vector into a column vector. Suppose Y has mean μ and covariance matrix Σ, with element (i, j) of Σ being σ_{i,j}. And let 1 denote the column vector of all 1's. Therefore, an alternative notation for ΣYᵢ is 1′Y. Next let p_{A} denote the column vector of all pᵢ's with iεA. Then an alternative notation for (Eq.(4) is as follows:

R=p_{A}′μ_{A}

For example, to focus on lost laptops, A would restrict i to only lost laptops. A could represent only a single laptop or all laptops in a particular department. As another example, to focus on all possible incident classifications impacting a specific department, A would consider only that department.

Calculating Expected Loss with a Zero-Inflated Continuous Distribution

Loss is a random variable following a zero-inflated continuous distribution, where the occurrence of 0 is indicated by a zero-one (Bernoulli) possibly multiplied by a weight multiplied by a value at risk, following a continuous distribution, as discussed elsewhere.

E(Z)=E(V′Y)=q′μ

where

q defined above; μ=E(Y|V) expected value of the value at risk given the random variable V, assumed constant

var(Z)=E(Z²)−(EZ)²=E{tr(V′YY′V)}−tr(q′μμ′q)

where tr(A)=the trace of the matrix A is the sum of its diagonal elements, applied here to a scalar, i.e., a 1×1 matrix. This is used, because tr(AB)=tr(BA), which gives the following:

$$\begin{matrix}var ( Z ) = E \{ tr ( {YY}^{′} {VV}^{′} ) \} - tr ( {μμ}^{′} {qq}^{′} ) \\ = tr \{ ( {Σ}_{y} + {μμ}^{′} ) Q \} - tr ( {μμ}^{′} {qq}^{′} ) \\ = tr ( {Σ}_{y} Q ) + tr \{ {μμ}^{′} ( Q - {qq}^{′} ) \} .\end{matrix}$$

Evaluating a Log Normal Distribution for Value at Risk from Samples

It may not be practical to assign a value at risk (or value at risk distribution) for every document in the enterprise. Instead, according to specific embodiments as discussed above, value at risk distributions are estimated for a sample of documents. These estimates are used to estimate a distribution of value at risk for an arbitrary document in a circulation pattern or some other secondary clustering, possibly given other explanatory variables like the size (number of bytes) of a document.

The same document could be indexed multiple times in this system with different values Yᵢ depending on the type of data and cybersecurity incident. In some embodiments, it is assumed that the distribution of Yᵢ is linearly related various potentially explanatory variables coded in a column vector xᵢ plus error as follows:

ln(Yᵢ)=xᵢ′b+eᵢ, Eq. 2

where
xᵢ′ denotes a row vector, being a the transpose of a column vector xᵢ of potential explanatory variables,
b is a column vector of weights to apply to the descriptors in xᵢ of the object i,
eᵢ represents random variability away from the xᵢ-adjusted mean, and
i represents data of a specific type in a particular document impacted by a designated type of cybersecurity incident.

According to specific embodiments of the invention, summaries of individual documents are presented to experts for the estimation of the value at risk of data that may be compromised in a cybersecurity incident. The expert judgments can then be combined across documents coding circulation patterns and other explanatory variables in the vectors xᵢ. Then the corresponding vector of weights b can be estimated using, e.g., Bayesian methods.

In some embodiments, standard theory for mixed effects modeling could be used assuming ln(Yᵢ) follows a normal distribution, decomposing the error terms, eᵢ, in the regression in similar ways as described in, e.g., Pinheiro and Bates (2000) Mixed-Effects Models in S and S-PLUS (Springer) and implemented in numerous contributed packages for R (r-project.org), including “nlme” and “lme4”.

In some embodiments, Yᵢ can represent the incremental loss from document and incident classification i given (U₁, Y₁, . . . , Uᵢ₋₁, Yᵢ₋₁). This allows the use of the present theory in situations where the total loss is different from the sum of the losses. For example, in the case where two different data files must be compromised together for a loss to occur. This can happen if one data file provides information required to understand the other. Then Y₂ can be huge but only if Y₁ has also been compromised, and (U₁Y₁+U₂Y₂) still express the loss involved in compromising both i=1 and 2. The opposite can occur in that two data files are sufficiently similar to be considered different document, but there is sufficient overlap in the contents that losing both involves no substantive loss beyond losing only one.

Expressions like (Eq.(5) are often used to determine sample size, because as the sample size increases, the uncertainties in p_{i,j} and σ_{i,j} will tend to be reduced. However, in many cases, biases are more important than random variability, and the biases do not appear explicitly in the math described here. This is particularly true for many embodiments of the current invention, because they rely to varying degrees on subjective evaluations by humans, and with subjective evaluations, biases can be larger than random variations.

### Example Mathematical Expressions

Methods according to specific embodiments can be further understood with consideration of the following specific example formulas and equations. As will be understood in the art, there are many was of expressing equations and the invention is not limited to specific mathematical expressions. According to specific embodiments, the above discussed methods determine the average annual risk (or expected loss) in dollars, calculated for computer c, from incident type i and data type j or (E(Z_{c,i,j}) from sampled documents as follows:

$$\begin{matrix}E ( {Y}_{c , i , j} ) = {\sum }_{Δ t}^{ } □ {D}_{c , j} & Eq . 6.1 a \\ E ( {Z}_{c , i , j} ) = {p}_{c , i} {F}_{i , j} E ( {Y}_{c , j} ) & Eq . 6.1 b\end{matrix}$$

where
D_{c,j} are the mean dollar values for data types j assigned to all documents (FIG. 1, step 3) found on computer c during time span Δt (FIG. 1, step 2);
Y_{c,i,j} is the value at risk for computer c and data type j and incident type i, where Δt is a function of i and is taken from the rubric in Table 6,
E(Z_{c,i,j}) is the average annual risk (or expected loss) in dollars, calculated for computer c, from incident type i and data type j;
p_{c,i} is the incident rate for incident type i assigned to computer c (FIG. 1, step 1);
F_{i,j} is the time span and multiplication factor as indicated in Table 6.

TABLE 6
Example method for Assigning F and Δt based upon Incident and Data type

| | | Incident Type | | |
|---|---|---|---|---|
| | | Espionage Malware | APT | Lost computer |
| Data | Custodial Data | F = 1, Δt ≧ 1 day < 365 days | F = 1, Δt ≧ 365 days | F = 1, Δt ≦ 1 day |
| Type | Proprietary Data | F = 1, Δt ≧ 1 day < 365 | F = 1, Δ ≧ t 365 days | F = 0.2, Δt ≦ t ≦ 1 days |
| | | days-30 days | | |
| | Third Party Data | F = 1, Δt = 30 days > 1 | F = 1, Δ ≧ t 365 days | F = 0.5, Δt ≦ 1 days |
| | | day-< 365 days | | |

In this example, Table 6 is characterized by:
1) a constant F, which is the fraction of value for each data type assumed to be compromised in each incident classification; and
2) an incident duration Δt assumed to be representative for that combination of incident and data type.

This table assumes that a value at risk for the loss of custodial and/or proprietary data in a specific document that is compromised by either espionage malware or APT is determined, for example by human expert evaluation. The method then applies a fraction F of 1 for those cases. It then assumes that the loss from the remaining 5 data and incident classification combinations is a different fraction: F=0.5 for loss of third party data due to espionage malware, APT or lost/stolen computer, and F=0.2 for proprietary data compromised via a lost/stolen computer.

In specific embodiments, this can be expressed as xᵢ=(0, 0)′ where F=1, and xᵢ=(1, 0)′ for these cases where F=0.5 and xᵢ=(0, 1)′ where F=0.2. Then the corresponding elements of b would be (ln(0.5), ln(0.2)). Then this portion of xᵢ′b in (Eq. 2) would give ln(1), ln(0.5), and ln(0.2) in these three cases. In this way, some parameters in b can be fixed while others estimated using a variety of techniques. Perhaps the most common technique used to estimate unknown parameters is least squares. However, many other techniques can be used in other embodiments.

Furthermore, once random samples are reviewed and minimum and maximum values are determined and recorded, the recorded values are optionally further multiplied by an expression K_{$} (which can be a constant or other rational expression relating the determined values to financial costs) to produce minimum and maximum values in dollars or other currency denominations (FIG. 3, step 3), and the mean and standard values are then calculated for each circulation pattern (FIG. 3, step 4) or other value at risk cluster.

In this specific example embodiment, a mean of the data type value is calculated for a circulation pattern cluster by summing the minimum and maximum dollar values for the given data type, across all randomly sampled documents for that circulation pattern, then dividing by twice the count of the number of random sample documents for the circulation pattern. A standard deviation of the data type value is calculated as the square root of the average of the difference squared between the mean data type value and each minimum and maximum value. In alternative embodiments, other value-at-risk clusters, such as value-at-risk clusters by topic modeling, can also have similar calculations.

According to further specific embodiments, a new version of the constant K_{$} can be calculated in two steps. First, the average cost of a lost laptop is calculated for the enterprise (FIG. 3, step 5), for example as follows:

$$M = \frac{{Σ}_{c , i} □ {R}_{c , i , j}}{N} \qquad Eq . 6.1 .2$$

where
M is the average financial impact from having a laptop lost or stolen,
R_{c,i,j} is from Equation 6.1 above, the sum is across all data types j, all computers c which are laptops, and incident type i is Lost or stolen laptop, and
N is the number of computers summed.

According to specific embodiments, this average value is compared with reported industry average values, and K_{$} is increased if the calculated average value is below the industry average values, or decreased if the calculated average value is above the industry average values (FIG. 3, step 6). After adjusting the constant K_{$}, the method for assigning values to circulation patterns is repeated (FIG. 3.step 7), with a new standard deviation values that requires additional random samples to accurately characterize circulation patterns. Further embodiments may rely on two or more human to rate the minimum and maximum value at risk of documents, with, for example, an average of the ratings used.

More generally, the distribution of the error terms in (Eq. 2) may be assumed constant or may vary with other factors involving the nature of the document, data type and cybersecurity incident type and the evaluator. These generalizations involve extensions of least squares known variously as mixed-effects modeling (fixed effects for the parameters b and random effects for the structure or the error terms, eᵢ's, as discussed by Pinhiero and Bates (2000) and standard R software cited above). In other embodiments, other distributions could be used in place of the log normal if they were believed to better model the random variability in the losses associated with cybersecurity incidents.

In particular, the probability distribution of Yᵢ in (Eq. 1) above for a data file is thus dependent on the circulation pattern or other value at risk clustering. According to specific embodiments, methods as described herein involve having expert-rated sample(s) of data clusters in terms of the potential loss from a cybersecurity incident. These samples are then used to model the probability distributions of data loss value of data clusters as functions of the circulation patterns of the data clusters using the sample data cluster data and other variables.

In other embodiments, text mining algorithms, and Natural Language Processing tools such as named-entity recognition, topic models, and information extraction methods may be used in addition to or in lieu of word histograms and circulation patterns to produce better estimates of the probability distributions of value at risk with little or no reliance on human expert evaluation of summaries of data file contents.

In other embodiments, estimated values of the value at risk probability distribution can be pre-assigned based on functions that are found in literature or functions that characterize patterns and structures in sets of data clusters defined by regular expressions and machine learning algorithms (e.g., artificial neural networks, sorting, and clustering algorithms).

### Lognormal Distribution in Estimating Value at Risk for Unstructured Data

Many phenomena in the economic and physical sciences involve quantities whose random variability can be adequately approximated using the log normal distribution (LN). In some embodiments, the marginal distribution of each component of a loss Yᵢ can be estimated using a simple subjective Bayesian procedure by asking experts to provide two different quantiles of a two-parameter distribution. These quantiles can then be inverted to compute the two parameters. For a normal or log normal distribution (LN) for the loss, Yᵢ, from compromising the information of (a specific data type in a specific document) i, can be specify by two symmetric quantiles.

Therefore, Yᵢ˜LNνᵢ, τᵢ) with mean νᵢ and standard deviation τᵢ. Their average is an estimate of the mean (or mean of the logarithms for a log normal distribution), and their difference estimates a certain number of standard deviations. From examining specific summary information about the document relative to the data type under consideration, an evaluator selects two numbers, a maximum and a minimum range (mᵢ, Mᵢ), which are believed to cover the central 68 percent of this distribution. For this purpose, it may be convenient to ask experts to specify points one standard deviation below and above the mean (or mean of the logarithms). Then the difference between the two values is approximately 2 standard deviations. By the definition of the log normal distribution, ln(Yᵢ) follows a normal distribution. Thus,

νᵢ=[ln(Mᵢ)+ln(mᵢ)]/2. Eq. 6

Similarly, since the central 68 percent of the normal distribution runs from one standard deviation below the mean to one standard deviation above, thus

τᵢ[ln(Mᵢ)−ln(m)]/2. Eq. 7

Using notation similar to (Eq. 2) above [ln(Yᵢ)=xᵢ′b+eᵢ], two elements of xᵢ could be (1, 1)′ for (Eq.(6) [with prime (′) denoting transpose] and (1, −1)′ for (Eq.(Eq. 7) with the corresponding elements of b being (νi, τᵢ), so in some embodiment the expression [ln(Yᵢ)=xᵢ′ b+eᵢ] can be represented as follows:

ln(Mᵢ)=(1,1)(νᵢ,τᵢ)′+e₁ᵢ=νᵢ+τᵢ+e₁ᵢ Eq. 8

and

ln(mᵢ)=(1,−1)(νᵢ,τᵢ)′+e₀ᵢ=(νᵢ−τᵢ)+e₀ᵢ Eq. 9

With the error terms, e₀ᵢ and e₁ᵢ, expressions (8) and (9) are 2 equations with 4 unknowns. Because there are exactly 2 equations here with 2 error terms, the least squares solution for the 2 other unknowns, νᵢ and τᵢ produces exactly (6) and (7).

Further embodiments may rely on two or more humans to rate the minimum and maximum values of documents. Accordingly, an average of the ratings is used. Averaging is introduced by assuming further structure on (νᵢ, τᵢ). For example, while i refers to a particular data type within a given document impacted by a specific cybersecurity incident, νᵢ may be shared across documents with a similar circulation pattern with adjustments for data and incident classification as suggested by (Eq.(2)2 above. This gives more equations than unknowns, ignoring the eᵢ error terms. The standard approach to similar problems has been least squares since its invention by C. F. Gauss around 1800. In some embodiments, it is assumed that some raters are more accurate than others; in such cases, maximum likelihood would produce a weighted least squares estimate for parameters like νᵢ and τᵢ.

More generally, the distribution of the error terms in (Eq.(2) may be assumed constant or may vary with other factors involving the nature of the document, data type and cybersecurity incident type and the evaluator. These generalizations involve extensions of least squares known variously as mixed-effects modeling (e.g., fixed effects for the parameters b and random effects for the structure or the error terms, eᵢ's, as discussed by Pinhiero and Bates (2000) and standard R software cited above). In other embodiments, other distributions could be used in place of the log normal to better model the random variability in the losses associated with cybersecurity incidents in various situations.

In particular, the probability distribution of Yᵢ in (Eq. 1) above for a data file is dependent on the circulation pattern or other value at risk clustering as described herein. According to specific embodiments, methods as described herein involve having expert-rated sample(s) of data clusters in terms of the potential loss from a cybersecurity incident. These samples are then used to model the probability distributions of data loss value of data clusters as functions of the circulation patterns of the data clusters using the sample data cluster data and other variables.

In other embodiments, text mining algorithms, and Natural Language Processing tools such as named-entity recognition, topic models, and information extraction methods may be used in addition to or in lieu of word histograms and circulation patterns to produce better estimates of the probability distributions of value at risk with little or no reliance on human expert evaluation of summaries of data file contents.

In other embodiments, estimated values of the probability distribution can be pre-assigned based on functions that are found in literature or functions that characterize patterns and structures in sets of data clusters defined by regular expressions and machine learning algorithms (eg. artificial neural networks, sorting, and clustering algorithms).

In some embodiments, experts assign relative rather than or in addition to absolute value at risk to estimated loss from compromising the information in a document, possibly within data type. In such cases, relative numbers can be converted to absolute numbers (in monetary terms like US dollars) by referencing externally available numbers like market capitalization, published loss values from previous cybersecurity incidents, and/or other related research and information sources.

### Estimating the Value at Risk for Structured Data

As discussed in more detail herein, according to specific embodiments, the value at risk for structured data can be characterized using an analysis of structured data recognizing that structured data is often organized into database tables of known purpose. The records in such a database can be assumed to have the same value at risk in the event of a data breach or a value at risk that corresponds with one or more fields in the record. Thus, structured data can be queried and counted or summarized. Generally, each record may be characterized in terms of a number of potentially explanatory variables typically including a data type like those in Table 3. According to specific embodiments, for structured data, each record is assigned a single value for each data type. The values assigned to each record are variable and may depend on such things as the number of records exposed in the data breach contractual obligations, and local laws or regulations. Records may represent people that are located in different geographical regions where the value at risk of a data breach may be different depending on where people are located, or where the breach occurs. In some embodiments, records can represent the number transactions from an online marketplace where revenue can be estimated for value at risk. Therefore, the method for saving queries may need to accommodate multiple queries and associated constants for each database.

In some embodiments, the value at risk for structured data can be characterized using a regression analysis such as linear equation, Generalized Linear Models, or Bayesian regression. Data is often organized into database files of known purpose, with multiple related records that have the same value at risk in the event of a data breach. According to specific embodiments, these can be queried and counted or summarized in order to determine value at risk.

Each record may be characterized in terms of a number of potentially explanatory variables typically including a data type like those in Table 3. For structured data, each record is generally assigned a single value for each data type. The values assigned to each record are variable and may depend on such things as the number of records exposed in the data breach, contractual obligations, and local laws or regulations. Records may represent people that are located in different geographical regions where the value at risk of a data breach may be different depending on where people are located, or where the breach occurs. In some embodiments, records can represent the number transactions from an online marketplace where revenue can be estimated for value at risk. Therefore, the method for saving queries may need to accommodate multiple queries and associated constants for each database. Equation 3.1 is an example function the value of single data type and a single record:

E[ln(Y_{d,j})]=b+(1+1/m)ln(n) Eq. 3.1

where:
n is the number of records in the database and
m, b are empirically derived constants for data type j and database d.
Y_{d,j} is the total value at risk for database d and data type j.

Generalizations of this model can include such things as industry, employment, country, and state. In different embodiments unknowns in such equations can be estimated using, e.g., least squares or maximum likelihood with generalized linear models or with mixture models, possibly supplemented with Bayesian methods.

In some embodiments, the database is a relational database where a record is distributed among several tables that can be joined. For example, a customer's personal data may be located in one table, and the customer's credit card information may be located in another table. Accordingly, methods for saving queries require the joining of tables and the counting of records for each database.

### Database Backups

Databases are sometimes backed up to a file that can be used to restore the database in case of accidents. Backup files often reside in the file system of a computer such as a server, workstation or laptop, file share, or storage media such as a tape backup. Database backups are also often copied and used by software developers to test changes to target databases. A database backup contains the same records as a target database when the backup was created and possesses the same financial impact, but has a different probability for a cybersecurity incident than the target database.

Value at risk for a database backup can be calculated using equation 1, but the value at risk generally should be the value of the target database when the database backup was created. The database backup file will likely have a file name similar to, but not identical to the target database. To calculate the value at risk for a database backup file, the invention must determine the target database and corresponding value at risk at the time of the backup.

### Modeling

In some embodiments, modeling may include an interactive user interface where users can modify variables that influence expected loss for different departments and predict the probability of future cybersecurity events using statistical and time series models. Expected loss can be represented in several aspects including tables, charts, graphs, and diagrams.

### Modeling Current Expected Loss

The expected loss of a enterprise can be estimated by summing risk over different data types, departments, and computers. This allows a user to present how expected loss (or risk) is distributed within an enterprise, showing locations of vulnerabilities and where monetary value is aggregated. In addition expected loss summations can be displayed with ranges represented by confidence intervals. In some embodiments, methods are provided to generate visual displays to illustrate different facets of the average annual risk (e.g., expected loss), which includes graphs, charts, and tables for the probability of one or more cybersecurity incidents within an enterprise.

In some embodiments where expected loss is represented by a vector of random variables, a vector is assigned the loss values, Z, for each computer, department, data type, or cybersecurity incident type or other grouping of incidents by appropriate selection of diagonal blocks in bdiag(V′). In further embodiments, a different block is included in “bdiag” for each computer, department and/or incident type. This supports computation of different risk analyses including, e.g, plotting impact-magnitude vs. frequency.

### Forecasting Future Incidents

In some embodiments, a time series profile is determined for risk based on a series of risk calculations at different times. Generalized linear models (GLM), artificial neural networks, ensemble methods, and Time series analysis methods such as Bayesian regression, Bayesian model averaging, least absolute shrinkage and selection operator (Lasso) regression, ridge regression, exponential smoothing equations, Box-Jenkins models, and Kalman Filtering are used to forecast future Expected Loss Risk. Some such models may include a sub-model varying volatility (such as generalized autoregressive conditional heteroskedasticity, GARCH) or non-normal increments or observation errors.

### Scenario Planning

Scenario planning allows users to simulate and compare expected loss risk when changes are made to their computer security software, access controls, and physical security. This is used to evaluate the benefits of software, alternative management policies, and modifications of the cybersecurity infrastructure of an enterprise. This can include simulating a substantial increase in a certain part of the organization, e.g., adding computers within a department due to growth or adding additional computers due to the purchase of a new subsidiary or that results from a business merger. This includes the use of return on investment (ROI) calculations to valuate changes made to the current cybersecurity system. A return on investment (ROI) value can sometimes be calculated for cybersecurity investments in technology, policies and activities (investments) if they cause a change in the expected loss. It is valuable to compare investments based upon their ROI since a higher ROI means a greater reduction of expected loss risk relative to the investment costs.

An ROI can be calculated by dividing the change in expected loss risk after the investment by the cost of the investment. For example, if the investment is anti-phishing training and the expected loss risk before the investment is $1,000,000 per year, and after is $500,000 per year and the cost of the investment is $20,000 per year, then the ROI is ($1,000,000−$500,000)/$20,000=$500,000/$20,000=25 times or 2,500%.

Many alternative scenarios are discrete, e.g., whether to upgrade the operating systems on a particular set of computers. Others may be continuous such as thresholds for value at risk on devices using a certain operating system, above which the operating system should be upgraded or the device replaced or a hard drive encrypted, and below which no such special expense is deemed worthwhile. With discrete alternatives, it may be easy to simulate them and produce terse summaries for management consideration. With multiple continuous alternatives, it may not be as easy to compute them all and display them in a simple summary. Especially if the cost of computing one scenario is not negligible, one might use designed experiments to map ROI as a function of the alternatives and seek an optimum subject to constraints as described, e.g., by Box and Draper (2007) Response Surfaces, Mixtures and Ridge Analysis, 2nd ed. (Wiley). There are by now a wide variety of techniques for numerical optimization subject to constraints well known to those skilled in the art and available in many widely available software packages or languages such as R, Python, Matlab, etc.

### Example 1

### Probability of an Occurrence of a Cybersecurity Incident as a Multivariate Bernoulli Random Vector U with 8 Components

In this example, a cybersecurity incident can involve a subset of incidents types listed in FIG. 2. For illustration, the probabilities of 8 different subsets are considered non-negligible. Then those 8 subsets are coded as a vector U with exactly one element being 1 and the other seven being 0. Then U=(1, 0, 0, 0, 0, 0, 0, 0)′ can code for the absence of a incident, U=(0, 1, 0, 0, 0, 0, 0, 0)′ codes for a lost computer, U=(0, 0, 0, 1, 0, 0, 0, 0)′ codes for APT, . . . , U=(0, 0, 0, 0, 0, 0, 0, 1)′ codes for a lost computer with both short term external espionage and an APT. If the probability of simultaneous occurrence of short term external espionage and APT is considered negligible (or not distinct from APT), then U does not need 8 components. U can have any fixed length. If, for example, only lost computer, external espionage and APT are considered to have non-negligible probability, U is represented by a vector of length 3. It is assumed that U is a random vector following a multivariate Bernoulli distribution.

In this example, exactly one element of U is 1; the other seven are 0. In this way, U codes for which subset of the three incident classifications are involved in a particular cybersecurity incident. Thus, 000 indicates the absence of any incident. 001 indicates losing a laptop that does not contain espionage malware or an APT. 111 denotes losing a laptop or another computer containing data, in which the laptop was also infected with espionage malware and an advanced persistent threat (APT). The probabilities of these 8 possible outcomes can be written as p₀₀₀, p₀₀₁, . . . , p₁₁₁ with all 8 non-negative and summing to 1.

When a cybersecurity incident occurs, e.g., when U≠000, a set of data files is compromised. In a large enterprise, this set of data files will vary over time depending on which data files are present or accessible by a computer involved or compromised by the incident. When this happens, the data loss value represented by a random variable as discussed below will depend on the data files involved. The set of data files compromised in the incident will usually coincide with the set of data files on the computer (or computers or storage devices) at the time or during the period of the incident.

Mathematically, if the potential loss associated with a data file i is a random vector Yᵢ with components Y_{i,j} for j=1, 2, 3 for the monetary value of custodial, proprietary and third party data contained in that data file. If Yᵢ is compromised in a cybersecurity incident U. Then referring back to equation 1, the loss from this incident can be written as follows:

Zᵢ=Uᵢ′FᵢYᵢ, Eq. 1(a)

where U is an 8-vector with one row containing 1 and the other seven rows with 0, and the matrix F can be specified, for example, by the last 3 columns of Table 6.

TABLE 6
Percentage Loss from Cybersecurity Incident
Classification/Data type combinations*

| 1. Lost | 2. Espionage | | | | Third |
|---|---|---|---|---|---|
| Laptop | Malware | 3. APT | Custodial | Proprietary | Party |
| 0 | 0 | 0 | 0 | 0 | 0 |
| 1 | 0 | 0 | 1 | 0.2 | 0.5 |
| 0 | 1 | 0 | 1 | 1 | 1 |
| 1 | 1 | 0 | 1 | 1 | 1 |
| 0 | 0 | 1 | 1 | 1 | 1 |
| 1 | 0 | 1 | 1 | 1 | 1 |
| 0 | 1 | 1 | 1 | 1 | 1 |
| 1 | 1 | 1 | 1 | 1 | 1 |

According to specific embodiments, systems and methods determine a reasonable approximation for the probability distribution of Yᵢ, or, in other words, determine a reasonable estimate for the likely value at risk (or data loss value) for a data file calculated using clustering based on circulation patterns.

### Example 2

### Impact-Magnitude vs Frequency Graphs

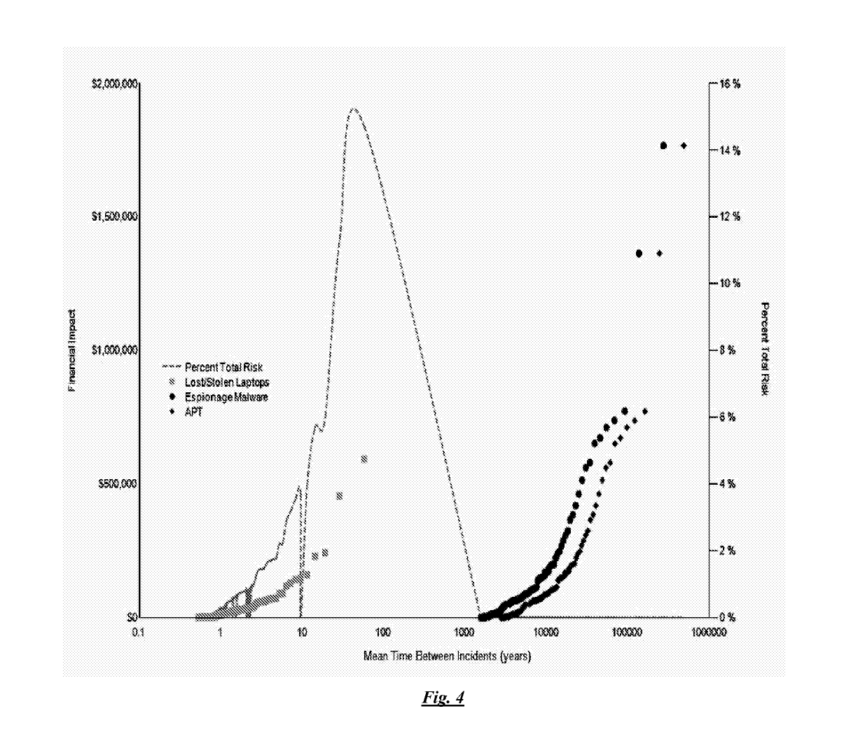

The calculation of average annual risk is performed by averaging across a distribution of possible events that have different frequencies and potential impacts. Often high impact events are rare, while low impact events are more common. This Impact-Magnitude vs Frequency relationship is a function of how high value data is distributed within the enterprise: often many computers and computer systems in an enterprise have a low impact potential, while a few computers and computer systems have a high impact potential. Predicting and displaying this underlying Impact-Magnitude vs Frequency relationship that makes up the average annual risk can be insightful since it can reveal high risk resources, and help make sense of why the average annual risk may seem much higher than losses experienced so far for an enterprise. In some embodiments, methods are provided to generate visual displays to illustrate different facets of the average annual risk. One way that the average annual risk can be displayed is through the use of an Impact-Magnitude vs Frequency graph. FIG. 4 illustrates the financial impact to an enterprise in dollars vs. the incident frequency in years. In this example, each point along the respective lines in the graph represents the predicted frequency with which an impact of that value or higher will occur. This type of visual display can help reconcile the experience of past security incidents with predictions, and help to identify high risk resources. The steps to create this type of plot are outlined in Tables 7 and 8. Mouse-over functionality is described in Table 9.

### Use of the Impact-Magnitude vs Frequency Graph

An example Impact-Magnitude vs Frequency graph is shown in FIG. 4. The graph shows the Impact-Magnitude vs Frequency curves for three types of security incidents: lost/stolen laptops (light gray squares), short term espionage (black circles) and advanced persistent threat or long term espionage (grey diamonds). Superimposed over the Impact-Magnitude vs Frequency curves is the Percent Total Risk curve (dashed line). Each Impact-Magnitude vs Frequency point on a curve represents the average incident frequency at the indicated Impact-Magnitude or greater. For example, the point (10, $200,000), means that an incident of $200,000 or greater is expected to occur every ten years on average. Because each point on each curve corresponds to a set of computers or systems, it is possible to display the set of computers for example when a viewer of the graph mouses-over a point. The Percent Total Risk curve can be used to assess the degree to which points on the Impact-Magnitude vs Frequency curves contribute to the overall risk for the enterprise. For example, the single point (50, $600,000) in the Lost/Stolen laptop curve accounts for 15% of the overall enterprise risk. Accordingly, this involves a single laptop computer and represents a fruitful place for the IT department to focus in its efforts to improve security of the computer system.

Generation of an Impact-Magnitude vs. Frequency Graph

Table 7 lists the steps for creating the Impact-Magnitude vs Frequency curve for a single incident type. These steps can be repeated for each incident type. Table 8 lists the steps for creating the Percent Total Risk Curve.

TABLE 7
Steps for Creating an Impact-Magnitude vs.
Frequency Curve for an Incident Type

| Step | Activity |
|---|---|
| 1 | An ordered list is created for all computers and systems within the |
| | enterprise. The list includes the computer or system identifier, |
| | mean time between incidents (MTBI) for the incident type, and |
| | the potential financial impact if the incident were to occur. The list |
| | is ordered from maximum to minimum potential financial impact. |
| | Example: |
| | Comp, MTBI, Impact |
| | LT2345, 0.02, $600,000 |
| | LT2367, 0.02, $523,000 |
| | LT2334, 0.02, $330,000 |
| | LT2312, 0.02, $150,000 |
| | etc. |
| 2 | For each row in the ordered list, an accumulated MTBI (AMTBI) |
| | is calculated by adding the MTBI values from the current row and |
| | all rows above. Example: |
| | Comp, MTBI, Impact AMTBI |
| | LT2345, 0.02, $600,000 0.02 |
| | LT2367, 0.02, $523,000 0.04 |
| | LT2334, 0.02, $330,000 0.06 |
| | LT2312, 0.02, $150,000 0.08 |
| | etc. |
| 3 | A plot is created using the ordered list, where Impact values are |
| | plotted against AMTBI. |
| | Example: (AMTBI, Impact) |
| | (0.02, $600,000) |
| | (0.04, $523,000) |
| | (0.06, $330,000) |
| | (0.08, $150,000) |
| | etc. |

Table 8 lists the steps for creating the Percent Total Risk Curve.

TABLE 8
Steps for Creating a Percent Total Risk Curve

| Step | Activity |
|---|---|
| 1 | A Total Risk is calculated for the enterprise. This Total Risk is |
| | created by summing across all E(Z_{d, i, j}) from |
| | equation 6.2b and all E(Z_{c, i, j}) from equation 6.1b. |
| 2 | In step 2, Table 7, a percent risk value is calculated for each row |
| | by multiplying the MTBI value by the Impact value then dividing |
| | by Total Risk. |
| | Example: Comp, MTBI, Impact AMTBI % Risk |
| | LT2345, 0.02, $600,000 0.02 100 × (0.02 × $600,000)/Total Risk |
| | LT2367, 0.02, $523,000 0.04 100 × (0.02 × $523,000)/Total Risk |
| | LT2334, 0.02, $330,000 0.06 100 × (0.02 × $330,000)/Total Risk |
| | LT2312, 0.02, $150,000 0.08 100 × (0.02 × $150,000)/Total Risk |
| | etc. |
| 3 | A plot is created using resuls from step 2 by plotting the % Risk |
| | values against the AMTBI values. |
| | Example: |
| | (AMTBI, % Risk) |
| | (0.02, 100 × (0.02 × $600,000)/Total Risk) |
| | (0.04, 100 × (0.02 × $523,000)/Total Risk) |
| | (0.06, 100 × (0.02 × $330,000)/Total Risk) |
| | (0.08, 100 × (0.02 × $150,000)/Total Risk) |
| | etc. |

Mouse-Over Functionality of the Impact Magnitude vs. Frequency Graph

According to specific embodiments, when the viewer of the Impact-Magnitude vs. Frequency graph mouses over a point (e.g., moves a cursor over the point), on the graph information about the computers associated with the point is displayed. Since the AMTBI value for each point is a sum of MTBI values, generally information about the computers with MTBI values that comprised the sum is displayed.

TABLE 9
Steps for Mouse-Oover Functionality

| Step | Activity |
|---|---|
| 1 | When the viewer of the Impact-Magnitude vs Frequency mouses-over a point for any curve generates in |
| | Table 7, the AMTBI value of the point is used to look-up the corresponding row in the ordered list from |
| | table 7 step 2. For example, if the viewer mouses over the point with AMTBI value of 0.04, then the |
| | indicated row would be found: |
| | Comp, MTBI, Impact AMTBI |
| | LT2345, 0.02, $600,000 0.02 |
| | LT2367, 0.02, $523,000 0.04 << mouse-over point |
| | LT2334, 0.02, $330,000 0.06 |
| | LT2312, 0.02, $150,000 0.08 |
| 2 | A list of computers is generated that includes the computer in the row identified in step 1 and all rows |
| | above in the ordered list. The following list would be generated from the example in step 1: |
| | LT2345 |
| | LT2367 |
| 3 | The list of computers from step 2 are displayed on the screen. |

Generalization of the Impact-Magnitude vs. Frequency Graph

Impact-Magnitude vs. Frequency graphs can be generated for any combination of incident and data type and many combinations of incident and data type. Impact-Magnitude vs. Frequency curves can be combined or displayed separately, and with or without Percent Total Risk curves. Percent Total Risk curves can also be generated for subtotal combinations such as Percent Total Custodial Data Risk. The mouse-over functionality can also be implemented as a mouse-click or mouse-double-click. The list of computers generated from the mouse-over functionality can be displayed in a floating window that appears over the graph, or in a separate place on the computer viewing screen or in a down-loadable file. The list of computers can include any kind of information to help the viewer identify and mitigate risk including the physical location of the computer, the department of the computer users, the email and phone number of the computer user.

### Other Displays or Outputs or Visualizations

Systems and methods according to specific embodiments provide a level of detailed value at risk and expected loss calculation that can be used to generate a wide variety of different outputs indicating different aspects of cybersecurity risk in an enterprise. A few examples are presented below.

### Example 3

### Determine Expected Loss Risk for an Enterprise from Structured Data

As discussed above, according to specific embodiments, structured data in an enterprise is also evaluated to determine value at risk and expected loss, but with variations to account for the differences in organization of the data. The following is an example method to calculate value at risk and expected loss for structured data. This method can be implemented as in Table 7, with a Query Database and computer program. The Query Database contains a set of queries and a history of value at risk and risk calculation results. The computer program first searches file systems for database backup files, then connects and executes queries against target databases, and calculates the value at risk and risk based on query results. An example Query Database schema is shown in Tables 15-22.

Each query in the Query Database is designed to measure the value at risk in a cybersecurity incident. One measurement can be the number of records associated with a specific data type, with a set of constants such as those given in equation 3.1 An example query might be:

SELECT COUNT(*) FROM Records WHERE Records.Country=‘USA’.

This query is for records in the United States, since the value at risk from exposing personal records is often a function of local or national laws, thus the multiplication constants in equation 3.1 depend on the geographical location or jurisdiction. Therefore, to measure the total value at risk of a data breach, the Query Database would contain a query and set of constants for each geographical location or jurisdiction for which there were records.

According to specific embodiments, the use of one or more fields, such as “country” to group or cluster records for the purposes of evaluating value at risk can be considered another type of value at risk clustering. Just as different documents are grouped according to circulation patterns or other relevant characteristics, different records can be grouped according various record characteristics, such as the value of one or more fields.

Risk from structured data is calculated using equations similar to that for unstructured data (see equations 6.1b) as follows:

$$\begin{matrix}E = ( {Y}_{d , j} ) = {\sum }_{n = 1}^{N} □ {Y}_{n , d , j} & Eq . 6.2 a \\ E ( {Z}_{d , i , j} ) = E ( {U}_{d , i} ) {F}_{i , j} E ( {Y}_{d , j} ) & Eq . 6.2 b\end{matrix}$$

where:
Y_{n,d,j} is the financial value at risk for query n, target database d and data type j, as calculated using equation 3.1 above
Y_{d,j} is the total value at risk for database d and data type j,
E(Z_{d,i,j}) is the average annual risk calculated in dollars for target database d, incident type i and data type j,
U_{d,i} is a zero-one (Bernoulli) random variable indicating (if 1) the presence of an incident impacting the target database d, and incident type i,
n is the number of queries for target database d,
F_{i,j} is the multiplication constant from the rubric in Table 10 above.

Table 11 contains steps the computer program in Table 8 executes to calculate the risk from target databases.

TABLE 11
Program Steps to Calculate Risk from Target Databases

| Step | Activity |
|---|---|
| 1 | At periodic time intervals, begin a new Calculation Cycle by creating a new CalculationID, insert a |
| | new row in the CalculationCycle table along with the date and time, then perform steps 2 through 6 |
| | below. |
| 2 | Execute each query in the Query table against its corresponding target database to obtain a record |
| | count. |
| 3 | For each query executed in step 2, calculate the value at risk based on the record count and constants |
| | such as m and b in equation 3.1. The financial impact is calculated using an equation similar to |
| | equation 3.1. |
| 4 | For each value at risk calculated in step 3, record the financial impact, QueryID, and CalculationID in |
| | the intermediate QueryImpactHistory table. |
| 5 | For each target database, the total of all value at risk just recorded in step 4 by data type using equation |
| | 6.2a and record the value at risk totals for each target database, in the DatabaseImpactHistory table |
| | along with CalculationID, DataType and TargetDatabase and new primary key DatabaseHisID. |
| 6 | Calculate the Risk values for each target database using equation 6.2b, where U_{d, i} values come from the |
| | DatabaseProbability table and impact totals come from step 5. Record the values in the RiskHistory |
| | table along with the date and time. |

Following are steps the computer program executes to assign the value at risk to database backup files. Since the DatabaseImpactHistory table contains the value at risk for target databases over time, assigning the value at risk to the database backup files amounts to assigning the corresponding DatabaseHisID from the DatabaseImpactHistory table. The following are steps performed by the computer program to find backup files and assign the value at risk to database backup files.

TABLE 11
Program Steps to Calculate Risk from Target Database Backup Files

| Step | Activity |
|---|---|
| 1 | For each calculation cycle in Table 13 step 1, also perform steps 2 through 6 below. |
| 2 | Search the file systems of computers within the enterprise to find database backup files. |
| 3 | For each database file is found in step 2, calculate a check-sum, read the create data from |
| | the file system, and insert an entry into the DatabaseBackups table (henceforth new entry) |
| 4 | For each new entry from step 3, search for a past entry in the DatabaseBackups table |
| | with a matching check-sum. If an entry is found insert a new set of rows into the |
| | DatabaseBackupsDatabaseHistory linking table with the BackupID of the new entry |
| | and the DatabaseHisID of the entry with matching check-sum, thus linking the new entry |
| | to the best matching set of value at risk numbers calculated for the corresponding |
| | database, o not execute steps 5 through 7. |
| 5 | If a matching check-sum is not found in step 4, then find the database name by searching |
| | the Database table for a string expression from the BackupFileNamesExpression |
| | column that matches the filename of the new entry. |
| 6 | Search the DatabaseImpactHistory for the set of entries with a database name that |
| | matches from step 5 and which are closets in time to the CreateDateTime of the new |
| | entry. Note that the date and time for the DatabaseImpactHistory table entries can be |
| | established by linking the entries to the CalculationCycle table through the |
| | CalculationID. |
| 7 | Insert a new set of rows into the DatabaseBackupsDatabaseHistory linking table with |
| | the BackupID of the new entry and the DatabaseHisID from the set of entries in the |
| | DatabaseImpactHistory table found in step 6, thus linking the new entry to the best- |
| | match set of value at risk numbers calculated for the most likely database. |
| 8 | The risk from each database backup file can now be calculated as the risk from the |
| | computer where the database backup was found using equation 6.1b. |
| | Note that it is common for a history of backup files to be saved for a single database. |
| | It is important to consider only the most recent backup file for a given database found |
| | on a computer. The following SQL query can be used with the schema below, to find |
| | the CalculationID for the most current set of value at risk calculations for all database |
| | backups found on a given computer. |

SELECT

Computer
,TargetDatabase
,max(CalculationID) ASMostCurrentCalculationID

FROM

DatabaseBackup
INNER JOIN

DatabaseBackupsDatabaseHistory DBDH
ONDBDH.BackupID=DB.BackupID

INNER JOIN

DatabaseImpactHistory DIH
ON DBDH.DatabaseHisID=DIH.DatabaseHisID

GROUP BY

DIH.TargetDatabase
,Computer

### Query Database Schema

Table 13, (CalculationCycle Table) is used to both establish the time of each calculation cycle and to create a key used to join calculation results from a particular calculation cycle. The primary key CalculationID will appear as foreign keys in many of the tables below.

TABLE 13
CalculationCycle Table

| CalculationID | DateTime |
|---|---|
| 1001 | 1/1/2015 21:00 |
| 1002 | 1/1/2015 22:00 |

Table 14 (Query Table) defines a set of queries constants and data types for each database within the enterprise that can be used to assess the value at risk in the case of a cybersecurity incident. The primary key QueryID will appear as a foreign key in other tables below.

TABLE 14
Query Table

| QueryID | TargetDatabase (d) | Queries | Constants | Data Type (j) |
|---|---|---|---|---|
| 101 | Production | SELECT COUNT(*) from Accounts | m = 3 | Personal |
| | | WHERE Country=’USA’ | b = 10 | Financial |
| 102 | Production | SELECT COUNT(*) from Accounts | m = 3.2 | Personal |
| | | WHERE Country=’Canada’ | b = 10 | Financial |
| 103 | Test | SELECT COUNT(*) from Accounts | m = 3 | Personal |
| | | WHERE Country=’USA’ | b = 10 | Financial |
| 104 | Test | SELECT COUNT(*) from Accounts | m = 3.2 | Personal |
| | | WHERE Country=’Canada’ | b = 10 | Financial |

Table 15 (QueryImpactHistory Table) contains a history of value at risk calculated for the queries in Table 14 (Query Table) and is a step in the calculation process to calculate the final value at risk registered in DatabaseImpactHistory table. The values in this table are the E(Z_{n,d,j}) values in equation 6.2a. The foreign key QueryID can be used to find data type and target database from the Query table.

TABLE 15
QueryImpactHistory Table

| QueryID | CalculationID | Impact |
|---|---|---|
| 101 | 1001 | $56,356,543,321 |
| 102 | 1001 | $15,246,112,865 |
| 103 | 1001 | $47,365,236,865 |
| 104 | 1001 | $11,321,312,765 |
| 101 | 1002 | $56,356,734,321 |
| 102 | 1002 | $15,246,802,111 |
| 103 | 1002 | $47,365,236,865 |
| 104 | 1002 | $11,321,312,765 |

Table 16 (DatabaseImpactHistory Table) contains a history of the final value at risk for each database, calculated by summing the value at risk by data type, at a given point of time from y Table 15. The values in Table 15 are the E(Z_{n,d,j}) values in equation 6.2a and 6.2b above. The DatabaseHisID is a Primary key that is assigned to entries in the DatabaseBackup table by way of the DatabaseBackupDatabaseHistory linking table, to establish the potential value at risk to database backup files found in the file system.

TABLE 16
DatabaseImpactHistory Table

| DatabaseHisID | TargetDatabase (d) | CalculationID | ImpactTotal (I) | DataType (j) |
|---|---|---|---|---|
| 1001 | Production | 1001 | $71,602,656,186 | Personal Financial |
| 1002 | Test | 1001 | $58,686,549,630 | Personal Financial |
| 1003 | Production | 1002 | $71,603,536,432 | Personal Financial |
| 1004 | Test | 1002 | $58,686,549,630 | Personal Financial |

Table 17 (DatabaseProbability Table) contains the probability values used to calculate risk in equation 6.2b for each target database.

TABLE 17
DatabaseProbability Table

| TargetDatabase (d) | IncidentType (i) | Probability (U) |
|---|---|---|
| Production | External Espionage | 0.00006 |
| Production | Internal Espionage | 0.00001 |
| Test | External Espionage | 0.00009 |
| Test | Internal Espionage | 0.00003 |

Table 18 (RiskHistory Table) contains a history of risk values calculated for each target database, broken down by incident type and data type.

TABLE 18
RiskHistory Table

| TargetDatabase (d) | CalculationID | IncidentType (i) | Data Type (j) | MeasuredRisk |
|---|---|---|---|---|
| Production | 1001 | External Espionage | Personal Financial | $4,296,159.37 |
| Production | 1001 | Internal Espionage | Personal Financial | $716,026.56 |
| Test | 1001 | External Espionage | Personal Financial | $5,281,789.47 |
| Test | 1001 | Internal Espionage | Personal Financial | $1,760,596.49 |
| Production | 1002 | External Espionage | Personal Financial | $4,296,159.37 |
| Production | 1002 | Internal Espionage | Personal Financial | $716,026.56 |
| Test | 1002 | External Espionage | Personal Financial | $5,281,789.47 |
| Test | 1002 | Internal Espionage | Personal Financial | $1,760,596.49 |

Table 19 (Database Table) is used to establish file naming patterns for the database backups. The column BackupFileNamesExpression contains standard string expressions for potential backup file names. Note that there can be multiple entries per database.

TABLE 19
Database Table

| TargetDatabase (d) | BackupFileNamesExpression |
|---|---|
| Production | Production[0-9] |
| Test | Test[0-9] |

Table 20 (DatabaseBackup Table) holds information about database backups found in the enterprise file systems. Note BackupID is the primary key and is used in the to link each backup file to a specific set of value at risk calculations for a database.

TABLE 20
DatabaseBackup Table

| FileName | Computer | Location | CreateTime | Checksum | BackupID | CalculationID |
|---|---|---|---|---|---|---|
| Production010120 | BackUps | C:\Prod\ | Jan. 1, 2015 | 57895438 | 10001 | 1001 |
| 142200.bck | | | 21:23 | | | |
| Production010120 | DevWorkStation | C:\Prod\ | Jan. 1, 2015 | 57895438 | 10002 | 1001 |
| 142200.bck | | | 21:23 | | | |
| Test.bck | DevWorkStation | C:\Prod\ | Jan. 1, 2015 | 36598201 | 10003 | 1001 |
| | | | 22:15 | | | |
| Production010120 | BackUps | C:\Prod\ | Jan. 1, 2015 | 57895438 | 10004 | 1002 |
| 142200.bck | | | 21:23 | | | |
| Production010120 | DevWorkStation | C:\Prod\ | Jan. 1, 2015 | 57895438 | 10005 | 1002 |
| 142200.bck | | | 21:23 | | | |
| Test.bck | DevWorkStation | C:\Prod\ | Jan. 1, 2015 | 36598201 | 10006 | 1002 |
| | | | 22:15 | | | |

Table 21 (DatabaseBackupDatabaseHistory Table) links each database backup file to a specific set of value at risk calculated for the corresponding database. Note that DatabaseHisID is a foreign key from the DatabaseImpactHistory table and BackupID is a foreign key to the DatabaseBackup table. Table 21 is needed since there can be multiple data type values associated with each database and therefore each backup file.

TABLE 21
DatabaseBackups DatabaseHistory Linking Table

| BackupID | DatabaseHisID |
|---|---|
| 10001 | 1001 |
| 10002 | 1001 |
| 10003 | 1002 |
| 10004 | 1001 |
| 10005 | 1001 |
| 10006 | 1002 |

### Embodiment in a Programmed Information Appliance

As will be understood to practitioners in the art from the teachings provided herein, specific embodiments can be implemented in hardware and/or software. In some embodiments, different aspects can be implemented in either client-side logic or server-side logic. As will be understood in the art, the invention or components thereof may be embodied in a fixed media program component containing logic instructions and/or data that when loaded into an appropriately configured computer cause that device to perform according to specific embodiments. As will be understood in the art, a fixed media containing logic instructions may be delivered to a user on a fixed media for physically loading into a user's computer or a fixed media containing logic instructions may reside on a remote server that a user accesses through a communication medium in order to download a program component.

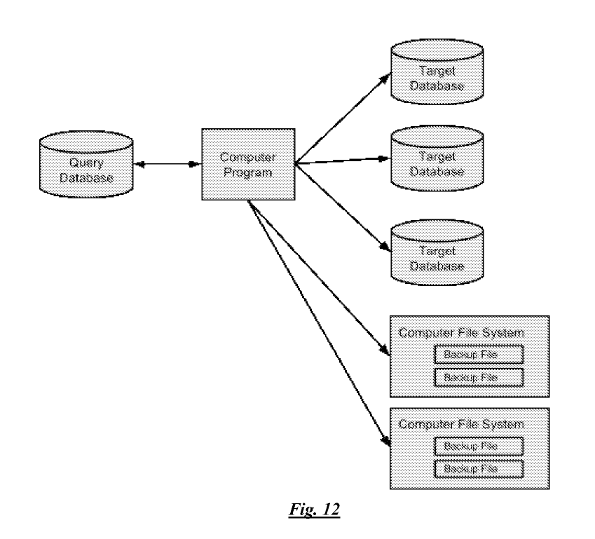

FIG. 12 shows a computer (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of specific embodiments as described herein. One type of logical apparatus that may embody the invention according to specific embodiments is a computer system as illustrated in 700, containing CPU 707, optional input devices 709 and 711, disk drives 715 and optional monitor 705. Fixed media 717, or fixed media 722 over port 719, may be used to program such a system and may represent a disk-type optical or magnetic media, magnetic tape, solid state dynamic or static memory, etc. In specific embodiments, the invention may be embodied in whole or in part as software recorded on this fixed media. Communication port 719 may also be used to initially receive instructions that are used to program such a system and may represent any type of communication connection.

Specific embodiments also may be embodied in whole or in part within the circuitry of an application specific integrated circuit (ASIC) or a programmable logic device (PLD). In such a case, specific embodiments may be embodied in a computer understandable descriptor language, which may be used to create an ASIC, or PLD that operates as herein described.

### Other Embodiments

Specific embodiments according to one or more descriptions of invention(s) disclosed here have been described. Any use of the term “invention” or “the invention” shall be understood to encompass one or more specific embodiments, but not necessarily all embodiments. The attached claims shall be used as the primary reference to determining the scope of the invention(s) taught herein. Other embodiments will be apparent to those of skill in the art.

For example, a user digital computer has generally been illustrated as a personal computer or workstation. However, the digital computer is meant to be any microprocessor-based device for interacting with a remote data application, and could include such devices as a digitally enabled television, cell phone, personal digital assistant, laboratory or manufacturing equipment, etc. It is understood that the examples and embodiments described herein are for illustrative purposes and that various modifications or changes in light thereof will be suggested by the teachings herein to persons skilled in the art and are to be included within the spirit and purview of this application and scope of the claims.

What is claimed:

1. A computer implemented method for classifying electronic data stored or accessed by a plurality of communicating computer devices in an enterprise comprising:
a. electronically scanning a plurality of data files available at a plurality of computers in the enterprise;
b. examining the contents or other attributes of data files to determine a plurality of data file groups (or documents) wherein a data file group comprises identical or highly similar data files;
c. creating a document record for each data file group and storing attributes for data files in a group in the document records;
d. grouping a plurality of documents into valuation groups, where a valuation group is used to collectively evaluate the value at risk for multiple documents;
e. evaluating one or more sample documents from a plurality of valuation groups to determine a value at risk for the documents;
f. assigning values at risk for documents in one or more valuation groups based on the evaluated risk of the sample documents for that group;
g. estimating a value at risk for an enterprise or part of an enterprise (e.g., a computer or group of computers) by combining the values at risk for documents accessible by the enterprise or part of the enterprise;
h. outputting estimated value at risk for an enterprise or part therefore.

2. The method according to claim 1 further wherein:
valuation grouping comprises grouping data stored in an enterprise into data clusters based on substantially equivalent attributes (e.g., word usage, departments where found, financial value)

3. The method according to claim 1 further wherein:
the data files are unstructured.

4. The method according to claim 1 further wherein:
one or more data files is identified as comprising structured data.

5. The method according to claim 1 further wherein the valuation grouping comprises grouping using one or more of:
circulation patterns of the files comprising documents;
regular expressions or artificial intelligence methods such as topic models, Naive Bayes, Support Vector Machines, and artificial neural networks for second level clustering
word histograms as a second level clustering (e.g. correspondence analysis can be used to perform a dimensional reduction and discover clustering)
second level clustering of database records, e.g., using database queries.

6. The method according to claim 1 further wherein:
documents are further analyzed to determine one or more data types; and
value at risk are separately evaluated for different data types.

7. The method according to claim 1 further wherein:
value at risk for documents is evaluated and assigned using probability distributions or random variables.

8. The method according to claim 6 further wherein:
multivariate probability distributions are assigned to different data types (e.g, Custodial data, Proprietary data, etc.);

9. The method according to claim 1 further wherein:
probability distributions for value at risk for valuation groupings are determined from one or more of:
expert evaluation (e.g., using random sampling);
industry data

10. The method according to claim 1 further wherein:
value at risk for a cluster is initially expressed or evaluated as a relative value and further comprising:
converting relative value at risk into financial values matching externally available numbers.

11. The method according to claim 1 further comprising:
storing circulation patterns for data files with stored document entries and estimating a probability distribution for value at risk by combining probability distributions of value at risk of a sample of the clusters.

12. The method according to claim 1 further comprising:
determining loss by combing incident random variables with value at risk variables.

13. The method according to claim 12 further comprising:
modeling incidents by type, systems, device and attributes with different weight factors for different data types.

14. The method according to claim 12 further comprising:
computing risk as expected loss.

15. The method according to claim 12 further comprising:
combining expected loss in various ways for identifying high risk computers or other enterprise components or for identifying anomalous risks or both.

16. The method according to claim 12 further comprising:
generating an impact vs. frequency curve for cybersecurity incidents and outputting that curve to provide an overall picture of enterprise cybersecurity risks.

17. The method according to claim 16 further comprising:
generating an impact vs frequency curve using random variable math (i.e. incorporating the idea that even the expected loss for a given computer is a random variable)

18. The method according to claim 16 further comprising modeling hypothetical changes to one or more characteristics of an enterprise and assessing risks to aid in cybersecurity risk abatement.

19. The method according to claim 1 further comprising:
determining incident probabilities for different kinds of cybersecurity incidents;
combining incident probabilities with value at risk probabilities to determine expected loss for an enterprise or part thereof in a given period.

20. The method according to claim 19 further comprising:
combining information sources (e.g. published or streaming) into probability distributions for cybersecurity incidents.

21. The method according to claim 19 further comprising:
computing incident probabilities from incident rates.

22. The method according to claim 19 further wherein the incident probabilities are expressed as a multivariate Bernoulli distribution.

23. The method according to claim 1 further comprising:
employing one or more statistical analysis methods as described herein to estimate and evaluate one or more of value at risk, expected loss, incident rate, according to any combination of different incident types and data types as described herein.

24. A computer-implemented method for assessing cybersecurity risk in an enterprise comprising:
a. electronically accessing data files available at a plurality of computers in the enterprise,
b. clustering data files into one or more levels of clusters based on data file similarity;
c. calculating a data loss value (or data loss distribution) for one or more of said clusters;
d. estimating cybersecurity risk for a computer from the data loss values (or data loss distributions) of data files previously accessed or present on the device;
e. estimating cybersecurity risk for an enterprise or part therefore from the risk of computers associated therewith; and
f. outputting estimated cybersecurity risk for an enterprise or part therefore.

25. The method according to claim 24 further comprising:
assessing data loss value for one or more clusters using a plurality of data loss risk values.

26. The method according to claim 24 further comprising:
estimating risk using plurality of incident types (classifications).

27. The method according to claim 24 further comprising:
clustering data files according to one or more circulation patterns determined for said data files.

28. A computer readable medium containing computer interpretable instructions that when loaded into an appropriately configured information processing device will cause the device to operate in accordance with the method of claim 24.
